(19) United States
(12) Patent Application Publication
(10) Pub. No.: US 2014/0010305 A1
(43) Pub. Date: Jan. 9, 2014

(54) METHOD OF MULTI-VIEW VIDEO SEQUENCE CODING/DECODING BASED ON ADAPTIVE LOCAL CORRECTION OF ILLUMINATION OF REFERENCE FRAMES WITHOUT TRANSMISSION OF ADDITIONAL PARAMETERS (VARIANTS)

(71) Applicant: Samsung Electronics Co., Ltd., Suwon-si (KR)

(72) Inventors: Kovliga Igor Mironovich, Chashnikovo (RU); Fartukov Alexey Mikhailovich, Moscow (RU); Mishourovsky Mikhail Naumovich, Moscow (RU); Dubkov Mikhail Sergeevich, Saint-Petersburg (RU)

(73) Assignee: SAMSUNG ELECTRONICS CO., LTD., Suwon-si (KR)

(21) Appl. No.: 13/933,477

(22) Filed: Jul. 2, 2013

(30) Foreign Application Priority Data
Jul. 3, 2012 (RU) 2012127528

(51) Int. Cl. H04N 7/34

(52) U.S. Cl. CPC H04N 19/00763
USPC 375/240.16

(57) ABSTRACT

There is provided a digital signal processing method which includes a method of adaptive local correction of illumination change of reference frame for multi-view video sequence encoding, comprising following stages: calculating a parameter of correction of illumination using pixels neighboring a currently decoded block and pixels neighboring a reference block; performing correction of illumination for the reference block using the parameter of correction of illumination; decoding the currently decoded block using the illumination-corrected reference.

### CROSS-REFERENCE TO RELATED APPLICATIONS

This application claims the priority benefit of Russian Application No. 2012127528, filed Jul. 3, 2012, in the Russian Intellectual Property Office, the disclosure of which is incorporated herein by reference.

### BACKGROUND

1. Field

Embodiments relate to digital signal processing, and more particularly to methods of corrections of differences in illumination, which can appear between frames of multi-view video sequence. Embodiments may be used at coding and decoding of multi-view video sequences.

2. Description of the Related Art

One of known from prior art methods applied for multi-view video sequence coding is concluded in usage of frames from adjacent views (perspectives) and also frames which are synthesized from frames of adjacent views (perspectives) and depth maps. Such frames are acted as reference frames for predictive coding (e.g. Yea, S.; Vetro, A., <<View Synthesis Prediction for Multiview Video Coding>>, Image Communication, ISSN: 0923-5965, Vol. 24, Issue 1-2, pp. 89-100, January 2009). Wherein a possible displacement of an object in current frame relatively to one of reference frames is compensated. The term <<displacement>> refers to the motion of an object or difference in position of an object between currently coded frame and frames from adjacent views (perspectives) or synthesized frame. Result of the compensation of the specified displacement is inter-frame difference minimization. The received inter-frame difference is coded then (for example, by applying decorrelated transformation, quantization and coding by entropy coder) and placed in output bit stream.

Possible differences in parameters of cameras which are used for multi-view video sequences capturing and also difference in light flux, coming from the objects of capturing to the cameras, lead to local differences of illumination between frames from difference perspectives. Specified differences in illumination also affect the characteristics of synthesized frames. It can lead to increase of absolute values of inter-frame difference that negatively affects efficiency of encoding.

In order to solve problem mentioned above, H.264 standard (ITU-T Rec. H.264. Advanced video coding for generic audiovisual services. 2010) uses a weighted prediction technique which is originally developed for effective coding of one-view (one-perspective) video sequences, in which effects of image fade-up and fade-down, flickering or scene change are met. Weighted prediction technique allows suppressing difference in illumination between coded frame and reference frames at the macroblock level. Wherein weighted factors are the same for all macroblocks of a particular slice. Weighting factors can be determined during coding and stored in output bit stream (<<explicit>>, weighted prediction) or calculated during encoding/decoding (<<implicit>>, weighted prediction). But in case of multi-view video sequences there are local illumination and/or contrast changes which make this technique ineffective.

Another approach to solve the problem is adaptive block-wise correction of difference in illumination, which is discussed in U.S. Pat. No. 7,924,923. Motion Estimation and Compensation Method and Device Adaptive to Change in Illumination. April, 2011. One of methods implementing the approach is the method of one-step affine illumination correction for multi-view video sequences (Multiview One-Step Affine Illumination Compensation—MOSAIC) as discussed in Y. Lee, J. Hur, Y. Lee, R. Han, S. Cho, N. Hur, J. Kim, J. Kim, P. Lai, A. Ortega, Y. Su, P. Yin and C. Gomila. CE11: Illumination compensation. Joint Video Team (JVT) of ISO/IEC MPEG and ITU-T VCEG JVT-U052, October 2006 and J. H. Kim, P. Lai, J. Lopez, A. Ortega, Y. Su, P. Yin, and C. Gomila. New coding tools for illumination and focus mismatch compensation in multiview video coding. IEEE Trans. on Circuits and Systems for Video Technology, vol. 17, no. 11, pp. 1519-1535, November 2007. The method supposes a combination of block-wise correction of difference in illumination with inter prediction techniques which are described in ITU-T Rec. H.264. Advanced video coding for generic audiovisual services. 2010. During such coding the mean values for the currently coded block and the reference block are calculated. Modified blocks are generated for the specified blocks by subtracting mean value for each pixel of the block. Then sum of absolute differences for received blocks (Mean-Removed Sum of Absolute Difference—MRSAD) is calculated. Result of the inter prediction is relative coordinates of reference block (displacement vector) which gives minimal value of encoding cost and also difference between the modified coded block and the modified reference block. Wherein calculation of the encoding cost is based on calculated MRSAD value and estimation of bit expenditures on transmitting the side information, necessary for further decoding. Besides displacement vector, side information also includes difference between mean values of current and reference blocks. This difference is called Difference Value of Illumination Compensation and is the parameter of illumination correction, DVIC value is exposed to differential encoding and placed in output bit stream. It is necessary to note, that in so-called <<P Skip>>, coding mode DVIC value is derived from DVIC values of adjacent macroblocks, which was already encoded for the moment of encoding of current macroblock. Therefore above method does not allow eliminating completely the necessity of explicit transmission of additional side information necessary for further decoding.

Parameters needed for correction of difference of illumination can be derived by analysis of restored (encoded and then decoded) areas of the frames. This can help to reduce amount of side information which should be encoded and transmitted explicitly in the bit stream. Mentioned technique was realized in the method of Weighted Prediction using Neighboring Pixels (WPNP), which is discussed in T. Yamamoto, T. Ikai, “Weighted prediction using neighboring pixels,” ITU-T Q.6/SG16 VCEG, Proposal VCEG-AH19, January 2008. This method utilizes values of pixels of coded frame neighboring the currently coded block and values of pixels of the reference frame neighboring the reference block for estimating pixel-wise illumination change. In this case illumination changes of two neighbor pixels are multiplied on weighted coefficients and added to be the estimation of illumination and contrast changes between separate pixels of current and reference blocks. It is necessary to note that weighted coefficients are computed for each pixel position of the coded block separately. Value of weighted coefficients depends on relative distance between pixel of coded block and selected neighbor pixels. Accuracy of carried out estimation is influenced by that illumination change of the pixels neighboring the coded and reference blocks can differ from change of illumination of the pixels, belonging directly to the coded and reference blocks and also that the method according to T. Yamamoto, T. Ikai, “Weighted prediction using neighboring pixels,” ITU-T Q.6/SG16 VCEG, Proposal VCEG-AH19, January 2008 considers only relative spatial pixel positions, but does not consider a relation of intensities of the corrected pixel and pixel from neighborhood.

Another variant realizing the approach, connected with illumination and contrast parameter estimation by analysis of restored (coded and then decoded) areas of the frames, is described in U.S. Patent Application Publication 2011/0286678. The method of coding multi-view video sequences, described in application includes correction of illumination difference during the predictive coding. The parameters of correction of illumination change are estimated from estimation of illumination change for adjacent areas of the coded and the reference blocks. Because the adjacent areas can be acquired both at coding and decoding, it is not necessary to explicitly transmit correction parameters in output bit stream. Obtained parameters are applied for correction of the reference block. Reliability of estimation of the illumination change parameters is determined by correcting of illumination for the area of the reference frame neighboring the reference block and comparing the obtained corrected area with restored (coded and then decoded) area of the coded frame neighboring the currently coded block. The drawback of mentioned method is that reliability of correction of illumination change is only determined by analysis of the adjacent areas. Information which is contained in the reference block is not used in analysis of reliability of correction of illumination change that can lead to erroneous correction decreasing its efficiency.

US Patent Application Publication No. 2008/0304760 discusses a method of correction for illumination and contrast change of reference block includes the following steps: receiving restored values of pixels neighboring the currently coded block and restored values of pixels neighboring the reference block; predicting mean values of pixels of currently coded block and the reference block, based on the restored values of pixels neighboring the currently coded block and the restored values of pixels neighboring the reference block; determining of the parameters of correction of illumination of the reference block based on the predicted mean value of the pixels of the currently coded block, the predicted mean value of the pixels of the reference block and the values of the pixels of the currently coded block and reference block; and performing illumination correction of the reference block, by using the determined previously illumination correction parameter.

The drawback of the prototype in US Patent Application Publication No. 2008/0304760 is as follows. Restored values of the pixels neighboring the currently coded block and the reference block are used for prediction of mean values only. This restriction does not allow using information which is contained in the neighboring pixels. Moreover, analysis of relations between values of the pixels from the reference block and values of the pixels neighboring the reference block is not performed. Thus, possible differences in parameters of correction of illumination change between considered blocks and areas neighboring the considered blocks are not considered. This can lead to decrease of reliability of procedure of correction of difference in illumination and contrast that negatively will influence the coding efficiency. Besides, the method does not allow registering presence of pixels in the adjacent areas which values, owing to the various reasons, for example because of quantization, appear very different from common set of pixels in adjacent areas. So accuracy of a final estimation of parameters of illumination correction can be essentially lowered. One more drawback of the prototype is that correction parameters are always transmitted in output bit stream that as a whole negatively affects efficiency of coding.

### SUMMARY

According to an aspect of one or more embodiments, there is provided at least one non-transitory computer readable medium storing computer readable instructions to implement methods of one or more embodiments

In an aspect of one or more embodiments, there is provided a method of correction of change of illumination between the reference frame and the currently coded frame for the inter-frame prediction of a multi-view video sequence, wherein such method includes
receiving values of pixels of a currently coded block belonged to coded frame and values of pixels of a reference block belonged to a reference frame;
receiving restored (encoded and then decoded) values of the pixels neighboring the current block of coded frame and values of the pixels neighboring the reference block of the reference frame; wherein the received pixels are selected from one or more spatial areas, each of which is characterized by beforehand set spatial proximity in relation to the current block of the coded frame and the current reference block of the reference frame; the selection of the specified areas, which are adjacent in relation to the current block of the coded frame and the current reference block of the reference frame, is performed proceeding from type and size of the spatial conversion applied subsequently for encoding of inter-frame difference, already decoded pixels, proceeding from the sizes of already coded neighboring blocks, and also their logic connections with the currently coded block (logic connections are understood as specified objectively existing dependences between the current block and the neighboring blocks, set, for example, by a coding method. In this case such connection can be combination of the neighboring blocks and the currently coded block together in a single element of encoding for which the common vector of displacement is set); the estimation of similarity of set of the pixels neighboring the coded block, and set of the pixels neighboring the reference block is calculated additionally. Value of the calculated estimation of similarity of pixels is used as an additional condition at decision-making on use of correction of illumination of pixels of the reference block.
excluding from consideration at determination of parameters of illumination change the pixels belonged to already decoded and restored areas of the reference and coded frames and which differed from the common selection (set) of pixels in the specified areas by the predetermined criterion, which is based on the analysis of distribution of values of pixels in the specified areas, computation of the static characteristics and also comparison of values of all pixels and static characteristics in the specified areas;
determining relations between the values of the pixels of the reference block and the values of the pixels neighboring the reference block and also relations between the restored values of the pixels neighboring the currently coded block and the values of the pixels neighboring the reference block;
determining an illumination change correction parameters for correction of difference in illumination between the reference block and the currently coded block based on the relations determined on the previous step, restored values of the pixels neighboring the currently coded block and values of the pixels neighboring the reference block;
performing correction of differences in illumination between the reference block and the currently coded block using the parameters determined on the previous step, in case if degree of similarity of pixels neighboring the coded block and considered together and pixels neighboring the reference block and considered together is greater than threshold value which is set beforehand or adaptively changes during the process of correction.

In an aspect of one or more embodiments, there is provided a more reliable adaptive procedure of an estimation of parameters of illumination change of the reference block, and also procedure of correction of illumination of the reference block.

In an aspect of one or more embodiments, there is provided a use of larger amount of data for an estimation of parameters of illumination change, and also the registration of existing connections between values of pixels of the reference block, the restored values of the pixels neighboring the reference block, and the restored values of pixels neighboring the coded block. Besides use of criteria of similarity of areas for detection of cases when correction can be inefficient is provided, new methods of detection of the pixels strongly different from set of pixels in adjacent areas, on which basis the estimation of parameters is carried out, are proposed, and also methods of excluding the detected strongly different values of pixels from the further consideration are proposed. In particular, in one or more embodiments, the analysis of relations between values of pixels of the reference block and values of the pixels neighboring the reference block, and also relations between the restored values of the pixels neighboring the currently coded block, and values of the pixels neighboring the reference block is carried out. At method implementation application of improved methods of encoding and decoding of multi-view video sequences is provided also, and such methods are based on use of illumination correction that allows to increase efficiency of compression due to that values of pixels which are accessible both at encoding and at decoding are used at estimation of illumination change. In this case parameters of illumination correction can be precisely restored without necessity of transmission of any additional data in output bit stream. Also at calculation of an estimation of parameters of illumination change it is offered to exclude from consideration pixels which belong to already decoded and restored areas of both reference and coded frames and which differ from other pixels of the specified areas by predetermined criterion. Such pixels we will name unreliable further.

In an aspect of one or more embodiments, there is provided a process of determination of relations between pixels of the currently coded frame and the reference frame, and also determination of parameters of illumination correction which includes:
calculation of statistic characteristics for the restored values of the pixels neighboring the currently coded block, statistic characteristics for pixels of the reference block and statistic characteristics for the pixels neighboring the reference block;
determination of relations between statistic characteristics for pixels of the reference block and statistic characteristics for the restored values of the pixels neighboring the reference block;
calculation of an estimation of value of the statistic characteristic for the currently coded block based on the calculated statistic characteristics and relations between them;
determination of parameter of correction of illumination change for correction of difference in illumination between reference and currently coded blocks based in the determined estimation of the statistic characteristic for the current block and the statistic characteristic of the reference block.

In an aspect of one or more embodiments, there is a method of illumination correction of the reference block during the coding of multi-view video sequence which includes:
receiving values of pixels of a current block of the coded frame and values of pixels of a reference block of the reference frame;
receiving restored (encoded and then decoded) values of the pixels neighboring the currently coded block and values of the pixels neighboring the reference block;
calculating of the first estimation estD_{i,j} for each position (i,j) of the pixel in the reference block; wherein the first estimation estD_{i,j} is a linear combination of the restored values Tₖ^{D} of the pixels neighboring the currently coded block, k=0, . . . , N−1, N is number of pixels neighboring the currently coded and reference blocks;
calculating the second estimation estR_{i,j} for each position (i,j) of pixel in the reference block; wherein the second estimation estR_{i,j} is a linear combination of values Tₖ^{R} of the pixels neighboring the reference block, k=0, . . . , N−1;
determining parameters of correction of illumination change for correction of each pixel in the reference block; wherein determination of these parameters is based on the value of the first estimation estD_{i,j}, value of the second estimation estR_{i,j} and also on values R_{i,j} of pixels of the reference block;
performing correction of illumination change for each pixel in the reference block using parameters of correction of illumination and contrast change determined on the previous step.

In an aspect of one or more embodiments, there is provided a method for the calculating of the first and the second estimation values for each pixel position in the reference block and the determining the parameters of correction of illumination change for each pixel position in the reference block includes:
calculating the first estimation value estD_{i,j} as

estD_{i,j}=Σ_{k=0, . . . ,N-1}Wₖ(i,j)·Tₖ^{D},
where Wₖ(i,j), k=0, . . . , N−1 are weighted coefficients, and Tₖ^{D}, k=0, . . . , N−1 is the restored values of the pixels neighboring the currently coded block, N is number of pixels neighboring the currently coded block and the reference block;
calculating the second estimation estR_{i,j} as estR_{i,j}=Σ_{k=0, . . . ,N-1}Wₖ(i,j)·Tₖ^{R}, where Wₖ(i,j), k=0, . . . , N−1 are weighted coefficients, and Tₖ^{R},k=0, . . . , N−1Tₖ^{R},k=0, . . . , N−1 are values of the pixels neighboring the reference block;
determining the parameter of correction of illumination change for correction of difference in illumination of each pixel position (i,j) in the reference block, this parameter is determined as

$${α}_{i , j} = \frac{{estD}_{i , j}}{{estR}_{i , j}} ,$$

if the second estimation estR_{i,j} is not equal zero. Otherwise α_{i,j}α_{i,j} is set equal 1.
performing correction of illumination change of the reference block by multiplication of value of each pixel of the reference block R_{i,j} on the parameter of correction α_{i,j}α_{i,j} corresponding to it.

In an aspect of one or more embodiments, there is provided a method for calculating of the first and the second estimation values for each pixel position in the reference block, and for the determining of the parameters of correction of illumination change for each pixel position in the reference block which includes
calculating the first estimation estD_{i,j} as

EstD_{i,j}=Σ_{K=0 . . . N-1}W_{K}(i,j)×L_{K}(i,j)×T_{K}^{D},
where Wₖ(i,j), k=0, . . . , N−1 and L_{K}(i,j), k=0 . . . N−1—are two sets of weighted coefficients, and Tₖ^{D},k=0, . . . , N−1—is the restored values of the pixels neighboring the currently coded block, N is number of pixels neighboring the currently coded and reference blocks;
calculating the second estimation estR_{i,j} as

EstR_{i,j}=Σ_{K=0 . . . N-1}W_{K}(i,j)×L_{K}(i,j)×T_{K}^{R},
where Wₖ(i,j), k=0, . . . , N−1 and L_{K}(i,j), k=0 . . . N−1—are two sets of weighted coefficients, and Tₖ^{R},k=0, . . . , N−1—Tₖ^{R}k=0, . . . , N−1—are values of the pixels neighboring the reference block;
determining the parameters of correction of illumination change for each pixel position (i,j) in the reference block; this parameter is determined as

$${α}_{i , j} = \frac{{estD}_{i , j}}{{estR}_{i , j}} ,$$

in case the second estimation estR_{i,j} is not equal zero. Otherwise α_{i,j}α_{i,j} is set equal 1;
performing correction of illumination change of the reference block by multiplication of value of each pixel of the reference block R_{i,j} on the parameter of correction α_{i,j}α_{i,j} corresponding to it.

In an aspect of one or more embodiments, there is provided a calculation of the first and the second estimation vales for each pixel position in the reference block which includes
calculating the weighted coefficients Wₖ(i,j), k=0, . . . , N−1 for the first estimation value estR_{i,j} and for the second estimation value estR_{i,j}; for each position (i,j) of pixel in the reference block the weighted coefficient Wₖ(i,j) is equal to the non-increasing function of an absolute difference:

|R_{i,j}−Tₖ^{R}|
that provides inverse proportional increasing/decreasing of value Wₖ(i,j) depending on decreasing/increasing the absolute difference. Here R_{i,j} is the value of the pixel of the reference block, Tₖ^{R}(k=0, . . . , N−1) is the value of the pixel neighboring the reference block; N is number of pixels neighboring the currently coded and reference blocks.

In an aspect of one or more embodiments, there is provided a calculation of the first and the second estimation vales for each pixel position in the reference block which includes
calculating the weighted coefficients L_{K}(i,j), k=0, . . . , N−1 for the first estimation value estD_{i,j} and for the second estimation value estR_{i,j}; for each position (i,j) of pixel in the reference block so that the weighted coefficient L_{K}(i,j) is equal to the non-increasing function ƒ of distance between pixels ∥R_{i,j},T_{K}^{R}∥:

L_{K}(i,j)=ƒ(∥R_{i,j},T_{K}^{R}∥)
that provides inverse proportional increasing/decreasing of value L_{K}(i,j) depending on approaching or distancing the pixel Tₖ^{R}(k=0, . . . , N−1) from the corrected pixel R_{i,j}. Here R_{i,j} is the value of the pixel of the reference block, Tₖ^{R}(k=0, . . . , N−1) is the value of the pixel neighboring the reference block; N is number of pixels neighboring the currently coded and reference blocks.

In an aspect of one or more embodiments, there is provided a method for calculation of the first and the second estimation vales for each pixel position in the reference block which includes
calculating the weighted coefficients Wₖ(i,j), k=0, . . . , N−1 for the first estimation value estD_{i,j} and for the second estimation value estR_{i,j}; for each position (i,j) of pixel in the reference block the weighted coefficient Wₖ(i,j) is equal to the non-increasing function of an absolute difference:

|R_{i,j}−Tₖ^{R}|,

that provides inverse proportional increasing/decreasing of value Wₖ(i,j) depending on decreasing/increasing the absolute difference; in case when |Tₖ^{R}−R_{i,j}|≦Thr, where Thr is a predefined threshold; otherwise Wₖ(i,j)=0. Here R_{i,j} is the value of the pixel of the reference block, Tₖ^{R}(k=0, . . . , N−1) is the value of the pixel neighboring the reference block; N is number of pixels neighboring the currently coded and reference blocks.

In an aspect of one or more embodiments, there is provided a method for calculation of the first and the second estimation vales for each pixel position in the reference block which includes
calculating the weighted coefficients Wₖ(i,j), k=0, . . . , N−1 for the first estimation value estD_{i,j} and for the second estimation value estR_{i,j}; for each position (i,j) of pixel in the reference block the weighted coefficient Wₖ(i,j) is equal to the non-increasing function of an absolute difference:

|R_{i,j}−Tₖ^{R}|,
that provides inverse proportional increasing/decreasing of value Wₖ(i,j) depending on decreasing/increasing the absolute difference; in case when |Tₖ^{R}−Tₖ^{D}|≦Thr1, where Tₖ^{D}(k=0, . . . , N−1)—is the value of the pixel neighboring the currently coded block, Thr1 is a first predefined threshold; and |Tₖ^{R}−R_{i,j}|≦Thr2, where Thr2 is a second predefined threshold; otherwise Wₖ(i,j)=0. Here R_{i,j} is the value of the pixel of the reference block, Tₖ^{R}(k=0, . . . , N−1) is the value of the pixel neighboring the reference block; N is number of pixels neighboring the currently coded and reference blocks.

In an aspect of one or more embodiments, there is a method which provides that calculation of the first and the second estimation vales for each pixel position in the reference block which includes
calculating weighted coefficients Wₖ(i,j), k=0, . . . , N−1 for the first estimation value estD_{i,j} and the second estimation value estR_{i,j}; for each pixel position (i,j) in the reference block the weighted coefficient Wₖ(i,j) is equal to Wₖ(i,j)=exp(−C1·Aₖ(i,j)^{C2}+C3, where C1,C2,C3 are parameters setting nonlinear dependence from the value Aₖ(i,j) and Aₖ(i,j), where it is determined as Aₖ(i,j)=|R_{i,j}−Tₖ^{R}|, R_{i,j} is the value of the pixel of the reference block, Tₖ^{R}(k=0, . . . , N−1) is the value of the pixel neighboring the reference block, in case of |Tₖ^{R}T−R_{i,j}|≦Thr, where Thr is a predefined threshold; otherwise Wₖ(i,j)=0.

In an aspect of one or more embodiments, there is provided parameters for determining the dependence of weighted coefficients Wₖ(i,j), in particular parameters C1, C2 and C3 can adaptively change depending on distance between pixel R_{i,j} in the reference block and pixels Tₖ^{R}(k=0, . . . , N−1) neighboring the reference block. Thus the registration of various influence of the pixels neighboring the current block and neighboring the reference block, and participating in calculation of correction parameters depending on distance to the corrected pixel R_{i,j} can be provided.

In an aspect of one or more embodiments, there is provided a method which provides that calculation of the first and second estimation values for each pixel position in the reference block which includes
calculating weighted coefficients Wₖ(i,j), k=0, . . . , N−1 for the first estimation value estD_{i,j} and the second estimation value estR_{i,j}; for each pixel position (i,j) in the reference block the weighted coefficient Wₖ(i,j) is equal to Wₖ(i,j)=exp(−C1·Aₖ(i,j)^{C2}+C3),where C1, C2, C3 are parameters setting nonlinear dependence from the value Aₖ(i,j); Aₖ(i,j) equals to Aₖ(i,j)=|R_{i,j}−Tₖ^{R}|, where is the value of the pixel of the reference block, Tₖ^{R}(k=0, . . . , N−1) is the value of the pixel neighboring the reference block, in case of |Tₖ^{R}−Tₖ^{D}|≦Thr1, where Tₖ^{D}(k=0, . . . , N−1) is the value of pixel neighboring the currently coded block, Thr1 is a first predefined threshold; and |Tₖ^{R}−R_{i,j}|≦Thr2, where Thr2 is a second predefined threshold; otherwise Wₖ(i,j)=0.

In an aspect of one or more embodiments, there is provided an estimation method of similarity of the restored pixels neighboring the reference block and the restored pixels neighboring the coded block, the method includes
all already restored pixels Tₖ^{R}(k=0, . . . , N−1) neighboring the reference block, and all already restored pixels Tₖ^{D}, k=0, . . . , N−1 neighboring the coded block, forming jointly pairs (Tₖ^{R}, Tₖ^{D}) uniquely set by spatial pixel positions Tₖ^{R}(k=0, . . . , N−1) and Tₖ^{D}, k=0, . . . , N−1 in corresponding areas which is determined by value of number of pixel k, are grouped in M non-intersecting groups G0 . . . GM−1, such that (Tₖ^{R}, Tₖ^{D}), k=0 . . . N−1ε{G₀∩G₁∩ . . . ∩G_{M-1}}. Pairs of the pixels belonging to the group Gi, are designated also as {(Tₖᵢ^{R},Tₖᵢ^{D})εGi}; for each group Gi the metrics is computed which is based on registration of pixel distinctions Tₖᵢ^{R} and Tₖᵢ^{D} except for distinction of mean values of all pixels Tₖᵢ^{R} and mean values of all pixels Tₖᵢ^{D} of each group Gi;
for each group Gi the metrics is computed based on distinctions of mean values of all pixels Tₖᵢ^{R} and mean values of all pixels Tₖᵢ^{D} of each group Gi;
the common metrics is computed, designated MR_Norm for groups G0 . . . GM−1 which is based on registration of pixel distinctions Tₖᵢ^{R} and Tₖᵢ^{D} by each of groups except for distinctions of mean values of all pixels Tₖᵢ^{R} and mean values of all pixels Tₖᵢ^{D} of each group Gi;
the common metrics is computed, designated M_Norm, for groups G0 . . . GM−1 which is based on registration of distinctions of mean values of all pixels Tₖᵢ^{R} and mean values of all pixels Tₖᵢ^{D} of each group Gi;
comparison of values of computed metrics MR_Norm and M_Norm is carried out with beforehand defined threshold values, and in a case if MR_Norm is greater than the first defined threshold value or M_Norm is smaller than the second defined threshold value, similarity of the restored pixels neighboring the reference block and restored pixels neighboring the coded block is considered weak; otherwise similarity of the restored pixels neighboring the reference block and restored pixels neighboring the coded block is considered strong;
if similarity of the restored pixels neighboring the reference block and restored pixels neighboring the coded block is weak, correction cannot be applied; if similarity of the restored pixels neighboring the reference block and restored pixels neighboring the coded block is strong, correction is carried out unconditionally.

In an aspect of one or more embodiments, there is provided a method where
for each group Gi the metrics MR_Norm(Gᵢ) is computed, which is based on registrations of pixel distinctions Tₖᵢ^{R} and Tₖᵢ^{D} except for distinction of mean values of all pixels Tₖᵢ^{R} and mean values of all pixels Tₖᵢ^{D} of each group Gi under the formula:

$$MR\_Norm ( {G}_{i} ) = {\sum }_{( {T}_{ki}^{R} , {T}_{ki}^{D} ) ∈ Gi}^{ } ( {\vert {T}_{ki}^{R} - {T}_{ki}^{D} - \frac{{\sum {T}_{ki}^{R}}_{( {T}_{ki}^{R} , {T}_{ki}^{D} ) ∈ Gi}^{ }}{\vert Gi \vert} + \frac{{\sum {T}_{ki}^{D}}_{( {T}_{ki}^{R} , {T}_{ki}^{D} ) ∈ Gi}^{ }}{\vert Gi \vert} \vert}^{P 1} ) ,$$

where value of polynomial index P1 is determined experimentally;
for each group Gi the metrics M_Norm(Gᵢ) is computed, based on distinctions of mean values of all pixels Tₖᵢ^{R} and mean values of all pixels if of each group Gi under the formula:

$$M\_Norm ( {G}_{i} ) = {\sum }_{( {T}_{ki}^{R} , {T}_{ki}^{D} ) ∈ Gi}^{ } ( {\vert \frac{{\sum {T}_{ki}^{R}}_{( {T}_{ki}^{R} , {T}_{ki}^{D} ) ∈ Gi}^{ }}{\vert Gi \vert} - \frac{{\sum {T}_{ki}^{D}}_{( {T}_{ki}^{R} , {T}_{ki}^{D} ) ∈ Gi}^{ }}{\vert Gi \vert} \vert}^{P 2} ) ,$$

where value of polynomial index P2 is determined experimentally;
the common metrics, designated as MR_Norm, is computed for groups G0 . . . GM−1, which is based on registration of pixel distinctions of pixels Tₖᵢ^{R} and Tₖᵢ^{D} by each of groups except for distinctions of mean values of all pixels Tₖᵢ^{R} and mean values of all pixels Tₖᵢ^{R} of each group Gi under the formula:

$$MR\_Norm = {\sum }_{i = 0 … M - 1}^{ } MR\_Norm ( {G}_{i} )$$

the common metrics, designated as MR_Norm, is computed for groups G0 . . . GM−1, which is based on registration of distinctions of mean values of all pixels Tₖᵢ^{R} and mean values of all pixels Tₖᵢ^{d} of each group Gi under the formula:

$$M\_Norm = {\sum }_{i = 0 … M - 1}^{ } M\_Norm ( {G}_{i} ) ;$$

comparison of values of calculated metrics MR_Norm and M_Norm is carried out with beforehand defined threshold values, and, if MR_Norm is greater than first defined threshold value or M_Norm is smaller than second defined threshold value, similarity of the restored pixels neighboring the reference block, and the restored pixels neighboring the coded block, is considered weak; otherwise similarity of the restored pixels neighboring the reference block and restored pixels neighboring the coded block is considered strong;
if similarity of the restored pixels neighboring the reference block and restored pixels neighboring the coded block is weak, correction cannot be applied;
if similarity of the restored pixels neighboring the reference block and restored pixels neighboring the coded block is strong, correction is carried out obligatory.

In an aspect of one or more embodiments, there is provided a method for F increasing of accuracy of estimation of difference of illumination of pixels of the reference block in comparison with coded block one or more embodiments provide that for excluding from consideration the obtained pixels Tₖ^{R} and Tₖ^{D}, which belong to already decoded and restored areas of reference and coded frames and which differ from common selection (set) of pixels in the specified areas, following actions are carried out:
grouping pixels Tₖ^{D} so that for all pixels Tₖ^{R}, satisfying condition Tₖ^{R}>LRᵢ and Tₖ^{R}<LRᵢ₊₁ the pixels Tₖ^{D} which correspond to pixels Tₖ^{R} proceeding from their serial number k=0 . . . N−1 and spatial position in reference and coded frames, are grouped in the groups designated as B(LRᵢ,LR₁₊₁);

$$B ( {LR}_{i} , {LR}_{i + 1} ) = \{ {{T}_{k}^{D}}_{k = 0 … N - 1} \text{:} {T}_{k}^{R} > {LR}_{i} ⋀ {T}_{k}^{R} < {LR}_{i + 1} \} ,$$

wherein values LRᵢLRᵢ₊₁ define limitations of range determining group B(LRᵢ,LRᵢ₊₁) and satisfy to condition LRᵢ>−1; LRᵢ₊₁>Rᵢ. The number of groups B(LRᵢ,LRᵢ₊₁) N_{B} is defined experimentally and sets the largest possible value of the index i, used at numbering of values (LRᵢ,LRᵢ₊₁):−1<LR₀<LR₀<LR₀ . . . <LR_{NB};
following values are calculated for each group B(LRᵢ,LRᵢ₊₁), defined by values (LRᵢ,LRᵢ₊₁);

$$C\_Plus ( LRi , LRi + 1 ) = {\sum }_{{T}_{k}^{D} ∈ B ( LRi , LRi + 1 )}^{ } \{ \begin{matrix}1 , {T}_{k}^{R} \geq {T}_{k}^{D} + Thr 5 \\ 0 , {T}_{k}^{R} < {T}_{k}^{D} + Thr 5\end{matrix} \\ C\_Minus ( LRi , LRi + 1 ) = {\sum }_{{T}_{k}^{D} ∈ B ( LRi , LRi + 1 )}^{ } \{ \begin{matrix}1 , {T}_{k}^{R} \leq {T}_{k}^{D} - Thr 5 \\ 0 , {T}_{k}^{R} > {T}_{k}^{D} - Thr 5 ,\end{matrix}$$

three following conditions are checked if they are satisfied for each pixel Tₖ^{D}ε(LRi,LRi+1) of the group B(LRᵢ,LR₁₊₁):

Condition1:

/C_Plus(LRᵢ,LRᵢ₊₁)−C_Minus(LRᵢ,LRᵢ₊₁)/<Thr6;

Condition2:

C_Plus(LRᵢ,LRᵢ₊₁)−C_Minus(LRᵢ,LRᵢ₊₁)>=Thr6 AND Tₖ^{R}≧Tₖ^{D}+Thr5;

Condition3:

C_Plus(LRi,LRi+1)−C_Minus(LRi,LRi+1)−Thr6 AND Tₖ^{R}≦Tₖ^{D}−Thr5
in case if one of the checked conditions 1 . . . 3 is satisfied for the next considered pixel Tₖ^{D}εB(LRi,LRi+1) of the group B(LRᵢLRᵢ₊₁), the considered pixel Tₖ^{D}εB(LRi,LRi+1) is included in the further calculations of parameters of correction of illumination of the reference block.

In a aspect of one or more embodiments, there is provided a method directed on increasing of accuracy of estimation of difference of illumination of pixels of the reference block in comparison with the coded block,

for all determined above pairs of pixels {(Tₖ^{R},Tₖ^{D})} the pixels Tₖ^{R} are considered so that Tₖ^{R}>LRᵢ and Tₖ^{R}<LRᵢ₊₁ and the pixels Tₖ^{D} which correspond to pixels Tₖ^{R} are grouped in the groups designated as B(LRᵢ,LRᵢ₊₁):

$$B ( {LR}_{i} , {LR}_{i + 1} ) = \{ {{T}_{k}^{D}}_{k = 0 … N - 1} \text{:} {T}_{k}^{R} > {LR}_{i} ⋀ {T}_{k}^{R} < {LR}_{i + 1} \} ,$$

values LRᵢ, LRᵢ₊₁ define limitations of range determining group B(LRᵢ,LRᵢ₊₁) and satisfy to condition LRᵢ>−1; LRᵢ₊₁>Rᵢ. The number of groups B(LRᵢ,LRᵢ₊₁) N_{B} is defined experimentally and sets the largest possible value of the index i, used at numbering of values (LRᵢ,LRᵢ₊₁):−1<LR₀<LR₀<LR₀ . . . <LR_{NB};
following values are calculated for each pixels Tₖ^{D}, belonging to the group B(LRᵢLRᵢ₊₁):
   mean value Mean(B(LRᵢ,LRᵢ₊₁)) by group B(LRᵢ,LRᵢ₊₁) is calculated by the formula:

$$Mean ( B ( {LR}_{i} , {LR}_{i + 1} ) ) = \frac{{\sum ( {T}_{k}^{D} )}_{{T}_{k}^{D} ∈ B ( LRi , LRi + 1 )}}{\vert B ( {LR}_{i} , {LR}_{i + 1} ) \vert} ,$$

where |B(LRᵢ,LRᵢ₊₁)| designates the number of pixels in the group B(LRᵢ,LRᵢ₊₁).
   Median value Med(B(LRᵢ,LRᵢ₊₁)) by the group B(LRᵢ,LRᵢ₊₁), defined as such value of the pixel belonging to the group B(LRᵢ,LRᵢ₊₁) that the number of the pixels which are belonging to the group B(LRᵢ,LRᵢ₊₁) and not exceeding by its value determined median value, is equal to the number of pixels belonging to the group B(LRᵢ,LRᵢ₊₁), which are not smaller that the determined median value of the group B(LRᵢ,LRᵢ₊₁);
   the most probable value Mod(B(LRᵢ,LRᵢ₊₁)) in the group B(LRᵢ,LRᵢ₊₁);
   average deviation Dev(B(LRᵢ,LRᵢ₊₁)) of values of pixels in the group B(LRᵢ,LRᵢ₊₁), which can be calculated by one of the widely known formulas, allowing to estimate the parameters of spread of values of the pixels in the group B(LRᵢ,LRᵢ₊₁) for example in one of variants the value Dev(B(LRᵢ,LRᵢ₊₁)) can be calculated by the formula:

$$Dev ( B ( {LR}_{i} , {LR}_{i + 1} ) ) = \sqrt{\frac{{\sum {( {T}_{k}^{D} - Mean ( B ( {LR}_{i} , {LR}_{i + 1} ) ) )}^{2}}_{{T}_{k}^{D} ∈ B ( {LR}_{i} , {LR}_{i + 1} )}}{\vert B ( {LR}_{i} , {LR}_{i + 1} ) \vert}} ;$$

|B(LRᵢ,LRᵢ₊₁)| designates number of pixels in the logic group B(LRᵢ,LRᵢ₊₁); in another realization the value Dev(B(LRᵢLRᵢ₊₁)) can be calculated by the formula:

$$Dev ( B ( {LR}_{i} , {LR}_{i + 1} ) ) = \sqrt{\frac{{\sum {( {T}_{k}^{D} - Mean ( B ( {LR}_{i} , {LR}_{i + 1} ) ) )}^{2}}_{{T}_{k}^{D} ∈ B ( {LR}_{i} , {LR}_{i + 1} )}}{\vert B ( {LR}_{i} , {LR}_{i + 1} ) \vert - 1}} ,$$

differing from the previous one by that estimation of deviation turns out not displaced that is especially important for a case of rather small number of elements in the group B(LRᵢ,LRᵢ₊₁); also the following formula can be applied for estimation of value of average deviation by the group B(LRᵢ,LRᵢ₊₁) with a purpose of simplification:

$$Dev ( B ( {LR}_{i} , {LR}_{j} ) ) = \frac{{\sum }_{{T}_{k}^{D} ∈ B ( {LR}_{i} , {LR}_{j} )} \vert {T}_{k}^{D} - Mean ( B ( {LR}_{i} , {LR}_{j} ) ) \vert}{\vert B ( {LR}_{i} , {LR}_{j} ) \vert}$$

experts can use also different ways of estimation of value Dev(B(LRᵢ,LRⱼ)), characterizing, as a matter of fact, a degree of spread of the pixels belonging to the group B(LRᵢ,LRᵢ₊₁).
For increasing of reliability of further estimations the exclusion from further consideration of that values of pixels of the group B(LRᵢ,LRⱼ), for which the module of difference between the value of single separate pixel and mean value by the group B(LR₁,LRⱼ) and/or median value by the group B(LRᵢ,LRⱼ) and/or most probable value by the group B(LRᵢ,LRⱼ) appears greater than value Dev(B(LRᵢ,LRⱼ)), calculated by one of widely known formulas, multiplied by value, greater 0, setting commonly admissible dispersion in the group B(LRᵢ,LRⱼ).

In an aspect of one or more embodiments, there is provided a method that positions of the recovered value of the pixels neighboring the currently coded block and positions of values of the pixels neighboring the reference block is determined adaptively instead the corresponding pixels with beforehand determined positions.

In an aspect of one or more embodiments, there is provided a method of encoding of multi-view video sequences based on correction of illumination change. This method includes:
determining a reference block that is used for generating a predicted block for a currently coded block;
determining parameters of correction of illumination for correction of local difference in illumination between the reference block and currently coded block during or after determination of the reference block;
performing correction of illumination of the determined reference block using the determined parameters of correction of illumination change;
generating the predicted block for the currently coded block using the illumination corrected reference block;
encoding the current block using the generated predicted block without encoding of determined parameters of correction of illumination change; encoding of information about the reference block if it is needed for decoding;
wherein the determining of the parameters of correction of illumination includes the following stages:
receiving reconstructed (encoded and then decoded) values of the pixels neighboring the currently block of the coded frame and values of the pixels neighboring the reference block of the reference frame; wherein obtained pixels can be selected from one or more spatial areas, each of which is characterized by beforehand determined spatial proximity in relation to the current block of the coded frame and the current reference block of the reference frame; selection of the specified areas being adjacent in relation to the current block of the coded frame and current reference block of the reference frame, can be performed proceeding from the sizes of already encoded neighbor blocks and also logic connections with currently coded block (logic connections are understood as specified objectively existing dependences between the current block and the neighboring blocks, set, for example, by a coding method. In this case such connection can be combination of the neighboring blocks and the currently coded block together in a single element of encoding for which the common vector of displacement is set); the estimation of similarity of set of the pixels neighboring the coded block, and set of the pixels neighboring the reference block is calculated additionally. Value of the calculated estimation of similarity of pixels can be used as an additional condition at decision-making on use of correction of illumination of pixels of the reference block;
excluding from consideration at determination of parameters of illumination change the pixels belonged to already decoded and restored areas of the reference and coded frames and which differed from the common selection (set) of pixels in the specified areas by the predetermined criterion, which is based on the analysis of distribution of values of pixels in the specified areas, computation of the static characteristics and also comparison of values of all checked pixels and static characteristics in the specified areas;
determining relations between the values of the pixels of the reference block and the values of the pixels neighboring the reference block and also relations between the restored values of the pixels neighboring the currently coded block and the values of the pixels neighboring the reference block;
determining an illumination correction parameters for correction of difference in illumination between the reference block and the currently coded block based on relations between values of the pixels of the reference block determined on the previous step, restored values of the pixels neighboring the currently coded block and values of the pixels neighboring the reference block;
performing correction of differences of illumination between the reference block and the currently coded block using the parameters determined on the previous step, in case if degree of similarity of pixels neighboring the coded block and considered together and pixels neighboring the reference block and considered together is greater than threshold value which is set beforehand or adaptively changes during the process of correction.

In an aspect of one or more embodiments, there is provided a method of decoding of multi-view video sequences based on correction of illumination and contrast change is provided also under the single design, which includes
decoding information about a reference block if it is needed for determining the reference block of the current block; determining the reference block;
determining parameters of correction of illumination change for the determined reference block;
performing correction of illumination change for the determined reference block using the determined parameters of correction of illumination change;
generating the predicted block for the currently decoded block using the illumination corrected reference block;
decoding the current block using the generated predicted block and the parameters of correction of illumination change;
wherein the procedure of determining of parameters of illumination correction includes:
receiving reconstructed (encoded and then decoded) values of the pixels neighboring the current block of the coded frame and values of the pixels neighboring the reference block of the reference block; wherein obtained pixels can be selected from one or more spatial areas, each of which is characterized by beforehand determined spatial proximity in relation to the current block of the coded frame and the current reference block of the reference frame; selection of the specified areas, being adjacent in relation to the current block of the coded frame and current reference block of the reference frame, can be performed proceeding from the type and the size of spatial transformation, further applied for encoding of inter-frame difference, already decoded pixels, proceeding from sizes of already encoded neighbor blocks and also logic connections with currently coded block (logic connections are understood as specified objectively existing dependences between the current block and the neighboring blocks, set, for example, by a coding method. In this case such connection can be combination of the neighboring blocks and the currently coded block together in a single element of encoding for which the common vector of displacement is set); the estimation of similarity of set of the pixels neighboring the coded block, and set of the pixels neighboring the reference block is calculated additionally. Value of the calculated estimation of similarity of pixels can be used as an additional condition at decision-making on use of correction of illumination of pixels of the reference block;
excluding from consideration at determination of parameters of illumination change the pixels belonged to already decoded and restored areas of the reference and coded frames and which differed from the common selection (set) of pixels in the specified areas by the predetermined criterion, which is based on the analysis of distribution of values of pixels in the specified areas, computation of the static characteristics and also comparison of values of all checked pixels and static characteristics in the specified areas;
determining relations between the values of the pixels of the reference block and the values of the pixels neighboring the reference block and also relations between the restored values of the pixels neighboring the currently coded block and the values of the pixels neighboring the reference block;
determining an illumination change correction parameters for correction of difference in illumination between the reference block and the currently coded block based on relations between values of the pixels of the reference block determined on the previous step, restored values of the pixels neighboring the currently coded block and values of the pixels neighboring the reference block;
performing correction of differences of illumination between the reference block and the currently coded block using the parameters determined on the previous step, in case if degree of similarity of pixels neighboring the coded block and considered together and pixels neighboring the reference block and considered together is greater than threshold value which is set beforehand or adaptively changes during the process of correction.

### BRIEF DESCRIPTION OF THE DRAWINGS

These and/or other aspects and advantages will become apparent and more readily appreciated from the following description of example embodiments, taken in conjunction with the accompanying drawings of which:

FIG. 1 is a block diagram of a hybrid multi-view video sequences encoder and place of application;

FIG. 2 is a block diagram of a part of the hybrid video encoder which implements proposed method which is included into the predictive coding;

FIG. 3 is a diagram representing the main elements of the coded, reference frames, which participates in calculation of correction of illumination change for the reference block;

FIG. 4 is a diagram illustrating a term of super-block, one of possible combinations of block sizes, which are part of super-block and also two types of spatial transformations used for decorrelation of the difference data;

FIG. 5 (view 5.1 and view 5.2) are diagrams illustrating the procedure of input block selection in a current frame during calculation illumination correction parameters, according to an exemplary embodiment of the present invention and also a term of spatial proximity;

FIG. 6 is a diagram illustrating a method of correction of illumination change for a reference block in accordance with an embodiment;

FIG. 7 is a flowchart illustrating a method of pixel-wise correction of illumination change for a reference block according to an embodiment;

FIG. 8 is a diagram for explaining a method of correction of illumination change for a reference block in accordance with an embodiment;

FIG. 9 is a flowchart which describes a method for multi-view video sequences encoding based on the correction of illumination change according to an embodiment; and

FIG. 10 is a flowchart which describes a method for multi-view video sequences decoding based on correction of illumination change according to embodiment.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

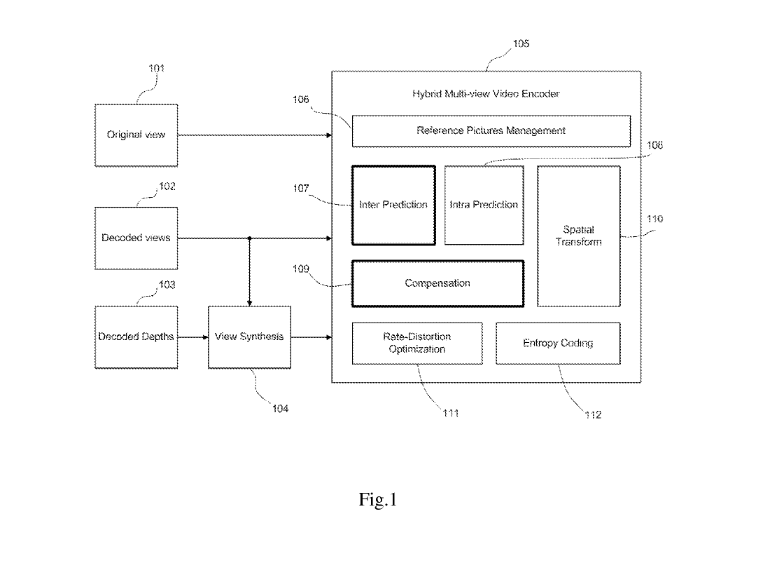

FIG. 1 shows the block diagram of a hybrid multi-view video sequences encoder. Input data of the hybrid multi-view video sequences encoder 105 includes original view (coded perspective) 101 and already coded and then decoded views (perspectives) 102 which are part of encoded multi-view video data. Already coded/decoded views 102 and already coded/decoded depth sequences 103 are used for generation of synthesized view (perspective) for the original view (coded perspective) by a view synthesis 104. The generated synthesized view (perspective) also arrives on input of the hybrid encoder 105.

The hybrid encoder 105 contains the following units which are used for encoding of the original view (perspective): reference picture management unit 106, inter-frame prediction unit 107, intra-frame prediction unit 108, inter and intra-frame compensation unit 109, spatial transform unit 110, rate-distortion optimization unit 111, entropy coding unit 112. More detailed information about mentioned functional units is given in Richardson I.E. The H.264 Advanced Video Compression Standard. Second Edition. 2010. One or more embodiments can be implemented inside inter-frame prediction unit 107.

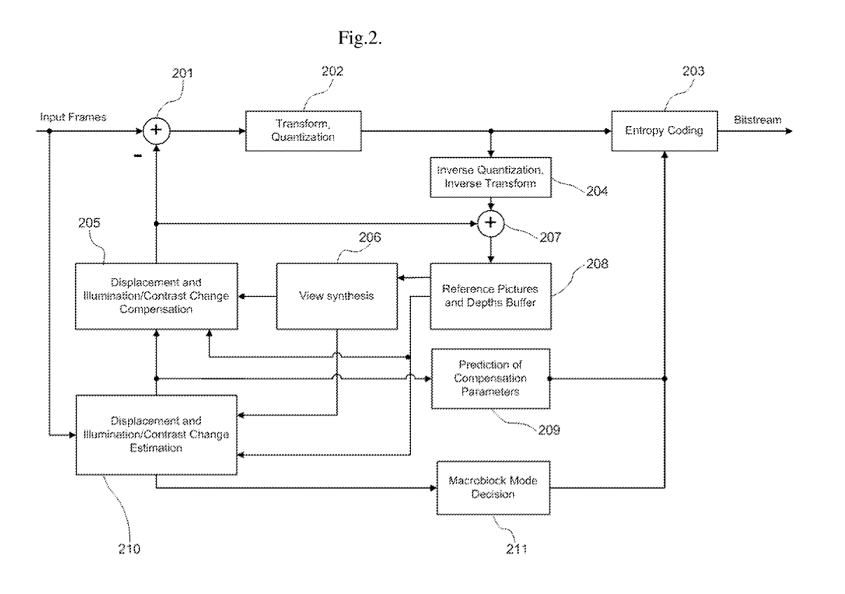

FIG. 2 depicts a scheme of a part of the hybrid video encoder which implements an embodiment which is included into the predictive coding functional unit. The hybrid encoder includes subtraction unit 201, transform and quantization unit 202, entropy encoding unit 203, inverse transform and inverse quantization unit 204, displacement and illumination/contrast change compensation unit 205, view (perspective) synthesis unit 206, addition unit 207, reference pictures and depth maps buffer unit 208, prediction of compensation and correction parameters unit 209, displacement and illumination/contrast change estimation unit 210 and macroblock encoding mode decision unit 211. Units 201-204, 207-209 and 211 are the standard encoding units which are used in the basic hybrid coding method [9]. View (perspective) synthesis unit 206 is a unit characteristic for the systems for multi-view coding, i.e. perform formation (synthesis) an additional reference frames from already encoded/decoded frames and depth maps.

An embodiment can be implemented inside units 205 and 210. These units realize block wise predictive coding technique, which contains following steps:
for the current block of the currently coded frame we search a reference block, wherein displacement vector (DV) is determined, set by a pair of numbers (i,j) which normally determines a cumulative optimum between bit expenses for encoding of a displacement vector itself and values of spacing between the coded block and the corrected reference block which can be, for example, is calculated under the formula:

$${\sum }_{m = 1}^{H} {\sum }_{n = 1}^{W} \vert {( I ( m , n ) - Ψ ( R ( m + i , n + j ) ) \vert}^{P}$$

where l(m,n) represents luminance value of pixel at position (m,n) inside the current block The size of the currently coded block equals H×W. (i,j) specifies displacement vector (DV) which points to the reference block R within a predefined search area. Ψ(x) means a function which corrects differences in illumination and contrast between the current block and the reference block. Degree exponent P, greater than 0, is usually takes one of values 1 or 2. The described technique is realized in the unit 210. Determined parameters of correction of illumination change along with obtained DV are transmitted to unit 205 and unit 209. At practical implementation, the displacement vector can be determined also at once for several blocks considered further with a purpose of more compact representation of a service information, in this case the criterion of minimization will be set for the super-block including at once several blocks considered further. In this case, the criterion of minimization can be set as follows:

$${\sum }_{m = 1}^{H 1} {\sum }_{n = 1}^{W 1} \vert {( I ( m , n ) - Ψ ( R ( m + i , n + j ) ) \vert}^{P} ,$$

where H1, W1 are sizes of super-block.
The displacement vector indicates the reference block corresponding the currently encoded block, and the displacement vector may be determined considering a discrepancy of luminance between the currently encoded block and the reference block.
The selected reference block is modified in according to determined parameters of correction of illumination change (unit 205). After that a residual block is created by unit 201. Then, the residual block is transformed by Discrete Cosine Transform (DCT), quantized (unit 202) and encoded by entropy encoder (unit 203). Side information (SI) required for further decoding is also encoded by entropy encoder (unit 203).

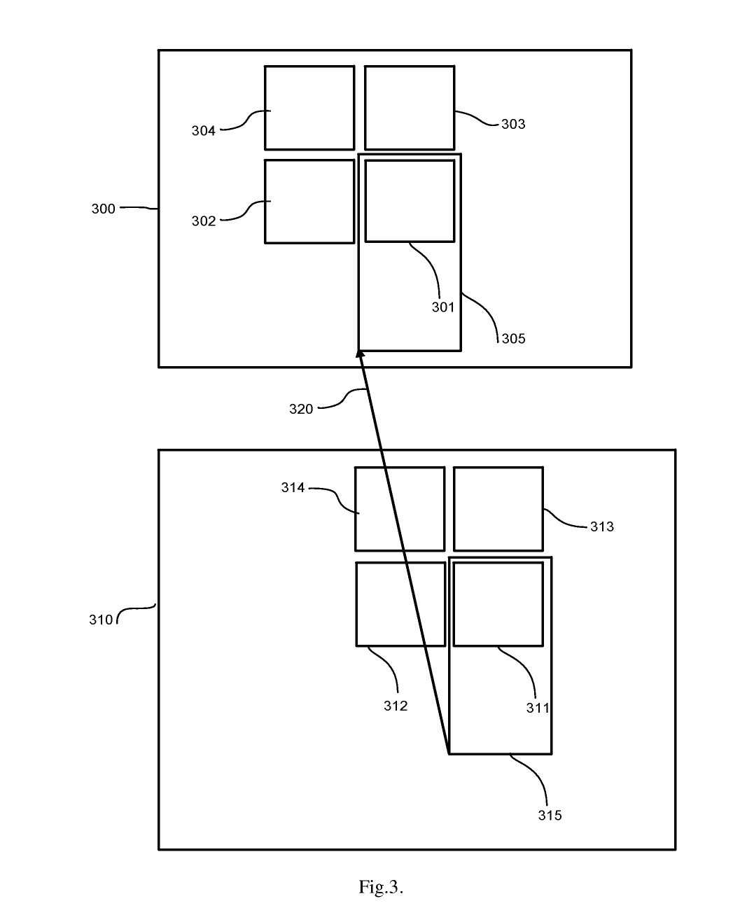

FIG. 3 schematically shows main elements of coded, reference frames, participating in calculation of correction of illumination change for the reference frame in accordance with an embodiment. Referring to FIG. 3 displacement vector (DV) 320, which can be determined also for the coded super-block 315, is determined for the current block 311 (which can be a part of the coded super-block 315) of the currently encoded frame 310. The vector 320 allows determining unequivocally the reference block 301 from the reference frame 300 for the currently coded block 311, wherein the displacement vector also unequivocally sets the reference super-block 305, which corresponds to the coded super-block 315. It is necessary to note that the reference frame 300, blocks 301, 302, 303, 304, 305 and restored (coded and then decoded) blocks of the current frame 310: 312, 313, 314 are accessible during encoding and also at decoding.

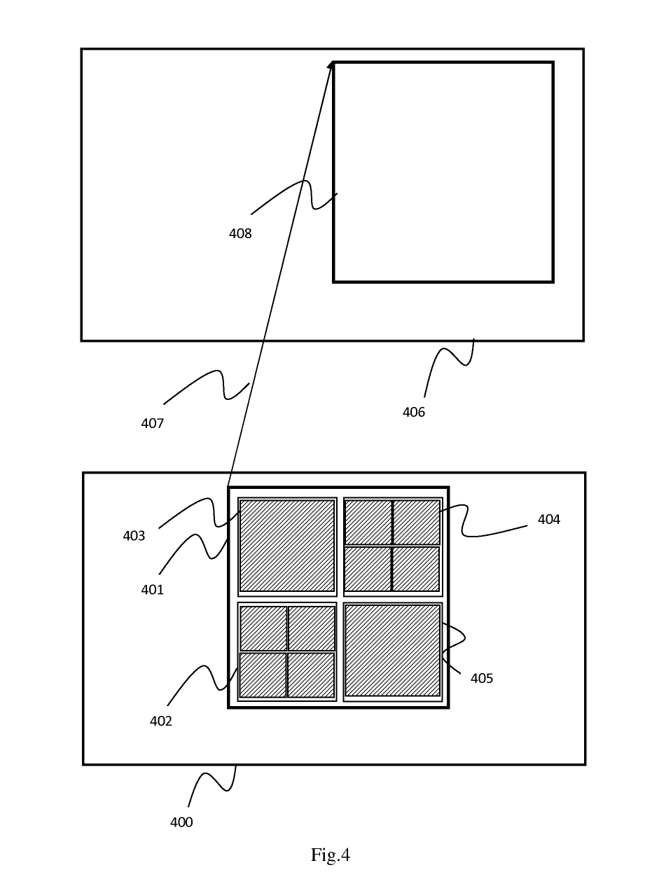

On FIG. 4 the coded frame 400 contains inside it the super-block 401 which is characteristic that it can contain one or more coded blocks, and for the super-block the displacement vector 407 is determined, which provides unequivocal determination of the reference super-block 408 in reference frame 406. The super-block 401 includes in this case blocks 402, 403, 404, 405, wherein the block 404, as well as the block 402, is coded using the transformation having the smaller dimension, than the transformation applied in the given example for blocks 403 and 405. The selection of the dimensions of the super-block, types and sizes of transformation is determined by the coder proceeding from the preset criteria of minimization of cost of information coding for the given section of the coded frame. As appears from FIG. 4, blocks 402, 403, 404, 405 are logically connected since they are part of the super-block 401 as components.

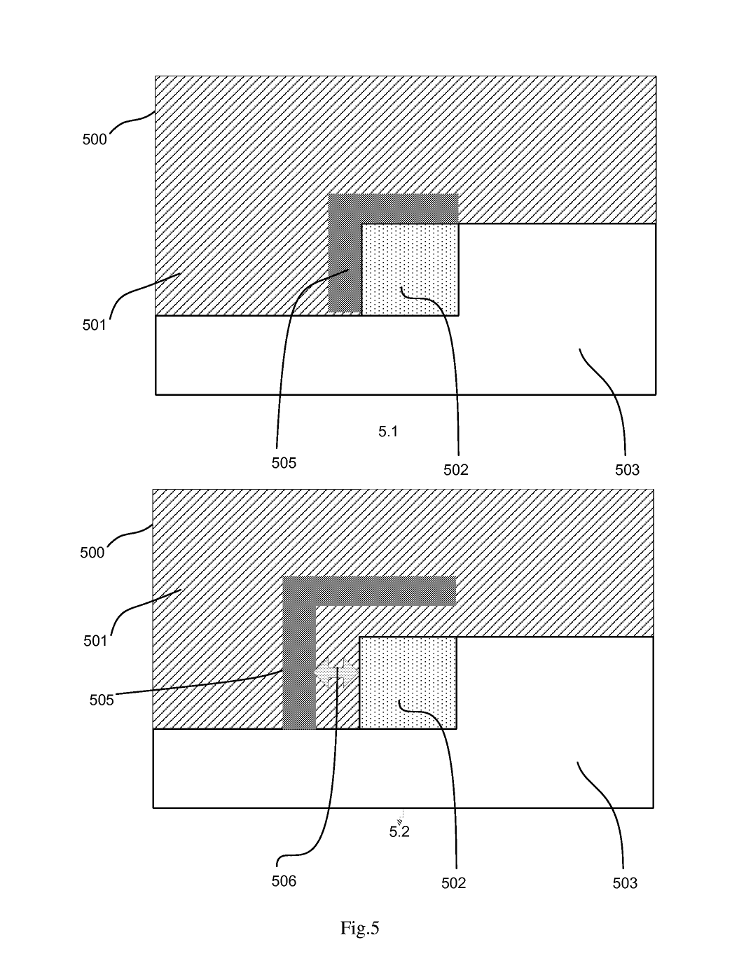

FIG. 5 (views 5.1 and 5.2) illustrate geometric relationship of the main considered in an embodiment areas of the current frame 500. So, the area 501 of the current frame 500 is accessible during encoding and decoding of the currently coded block 502. Area 501 is sometimes also called “template”. The area 503 is not accessible during decoding of the current block 502. As in an embodiment for calculation of parameters of correction of illumination of the reference block is based on pixels of the current frame which are located only in the area 501, at realization of similar correction in the coder and decoder there is no necessity for transmission of additional parameters of illumination correction in output bit stream. Some pixels belonging to area 501, are used for calculation of parameters of illumination correction of the reference block. These pixels are presented by area 505 on FIG. 5 (view 5.1 and 5.2).

The pixels used for calculation of parameters of correction, can be selected from one or more spatial areas, each of which is characterized by beforehand specified spatial proximity in relation to the current block of the coded frame and the current reference block of the reference frame; so on FIG. 5 (view 5.2) the selected spatial area is area 505, and the spatial proximity is determined by the shortest distance between area and edge of the block which is designated on FIG. 5 (view 5.2) as 506.

The selection of area can be made, proceeding from type of spatial transformation 202 (FIG. 2), applied subsequently for encoding difference pixel information, already decoded pixels, proceeding from the sizes of already coded neighbor blocks, and also their logic connections with the currently coded block, set by algorithm of encoding; the estimation of similarity of the pixels neighboring the coded block and considered together and the pixels neighboring the reference block and considered together is additionally calculated; value of the calculated estimation of similarity of pixels can be used as an additional condition at decision-making on use of correction of luminance of pixels of the reference block.

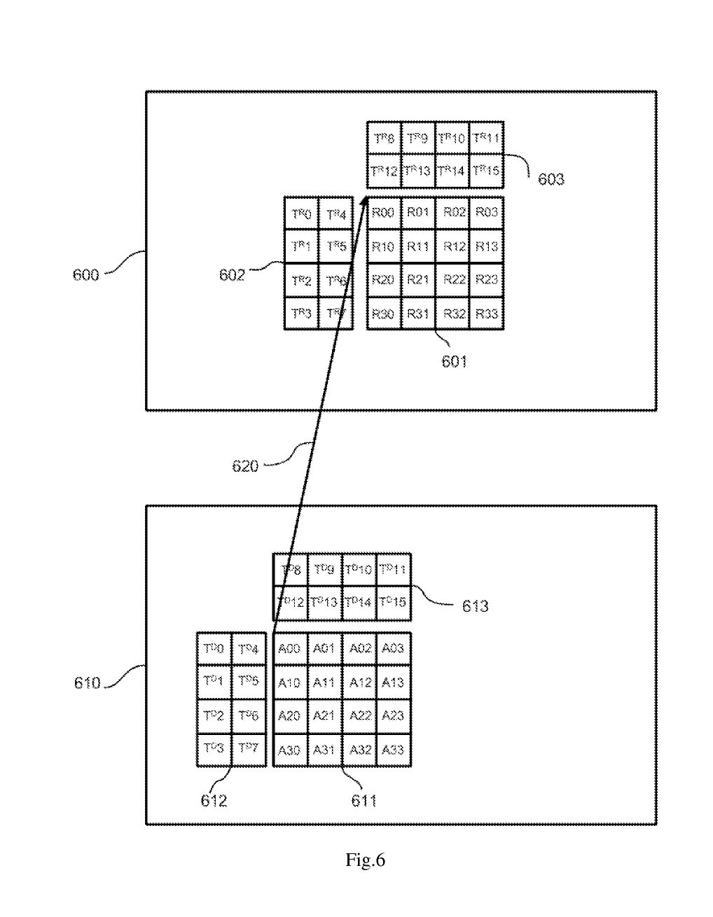

An embodiment provides pixel correction of illumination change for the reference block at encoding with a prediction. The key idea consists in pixel estimation of parameter of correction of illumination change, wherein correction is based on the restored values of the pixels neighboring the current block, values of pixels of the reference frame and their mutual similarity. FIG. 6 illustrates concrete application of this technique.

Referring FIG. 6, the displacement vector (DV) 620 is determined for the current block 611 that belongs to the currently encoded frame 610. The DV points to the reference block 601 of the reference frame 600. The current block 611, having 4×4 pixels for definiteness, contains pixels that are denoted as A00˜A33. The reference block 601 contains pixels that are denoted as R00˜R33. The restored values of the pixels (blocks 612 and 613, which sizes are set as 4×2 and 2×4 for definiteness) neighboring the currently coded block are denoted by To T₀^{D}˜T₁₅^{D}. T₀^{R}˜T₁₅^{R} are pixels belonging to blocks 602 and 603. Blocks 602 and 603 are neighboring blocks in relation to the reference block and put in conformity to blocks 612 and 613.

For each pixel position (i,j) in the reference block 601 the illumination change correction is performed in accordance with following equation:

Ψ(x_{i,j})=α_{i,j}·x_{i,j}.

Here the parameter of pixel-wise correction of illumination change α_{i,j} (if estR_{i,j} is not equal 0) is described as:

$${α}_{i , j} = \frac{{estD}_{i , j}}{{estR}_{i , j}} ,$$

where estD_{i,j} is the first estimation value for the pixel position (i,j) in the reference block; estR_{i,j} is the second estimation value for the pixel position (i,j) in the reference block. Otherwise α_{i,j} is assumed to be 1.

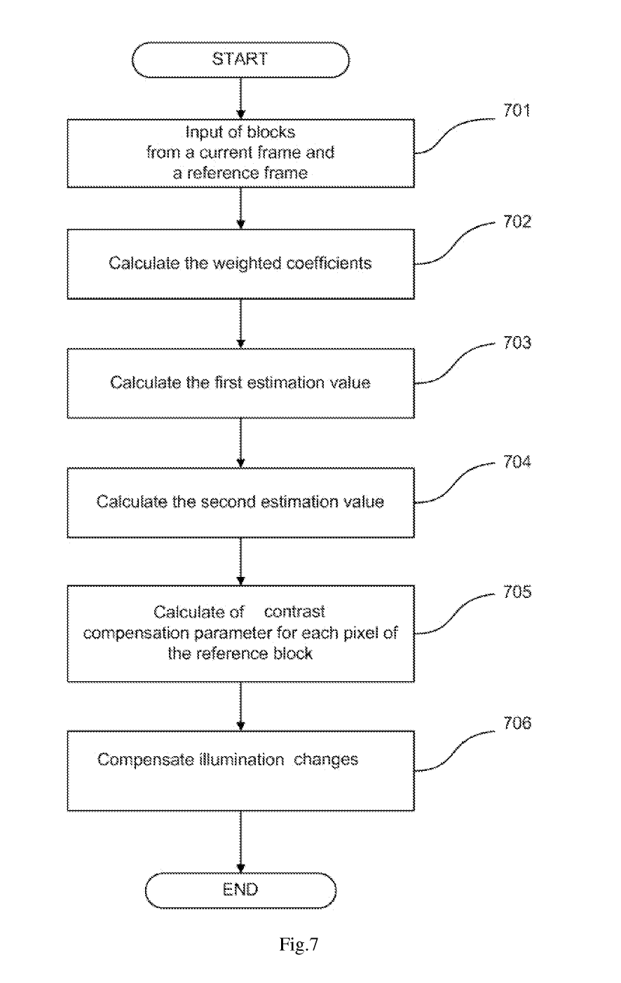

Flowchart of a method of pixel-wise correction of illumination change for a reference block is depicted in FIG. 7. The method includes the following main steps:
1. Receiving of values of pixel of blocks 601, 602, 603 from the reference frame 600, block 611 and blocks 612, 613 belonging to template area of the currently encoded frame 610 (operation 701). Then for an estimation of similarity of pixels of blocks 602, 603 and pixels of blocks 612, 613 following stages are provided:
   all already restored pixels Tₖ^{R}(k=0, . . . , N−1) neighboring the reference block (in particular pixels belonging to blocks 602 and 603), and all already restored pixels Tₖ^{D},k=0, . . . , N−1 (in particular pixels belonging to blocks 612 and 613) neighboring the coded block, forming jointly pairs (Tₖ^{R},Tₖ^{D}) uniquely set by spatial pixel positions Tₖ^{R}(k=0, . . . , N−1) and Tₖ^{D},k=0, . . . , N−1 in corresponding areas which is determined by value of number of pixel k, are grouped in M non-intersecting groups G0 . . . GM−1, such that (Tₖ^{R},Tₖ^{D}),k=0 . . . N−1ε{G₀∩G₁∩ . . . ∩G_{M-1}}. Group can be the block of pairs of pixels with generally speaking any sizes, for example—the sizes 2×2 pairs of pixels, 4×4 pairs of pixels etc. depending on the actual sizes of initial blocks 602, 603, 612, 613. Pairs of the pixels belonging to group Gi are designated also as {(Tₖᵢ^{R},Tₖᵢ^{D})εGi};
   for each group Gi the metrics MR_Norm(Gᵢ) is computed, which is based on registration of pixel distinctions Tₖᵢ^{R} and Tₖᵢ^{D} except for distinction of mean values of all pixels Tₖᵢ^{R} and mean values of all pixels Tₖᵢ^{D} of each group Gi, under the formula:

$$MR\_Norm ( {G}_{i} ) = {\sum }_{( {T}_{ki}^{R} , {T}_{ki}^{D} ) ∈ Gi} ( {\vert {T}_{ki}^{R} - {T}_{ki}^{D} - \frac{{\sum {T}_{ki}^{R}}_{( {T}_{ki}^{R} , {T}_{ki}^{D} ) ∈ Gi}}{\vert Gi \vert} + \frac{{\sum {T}_{ki}^{D}}_{( {T}_{ki}^{R} , {T}_{ki}^{D} ) ∈ Gi}}{\vert Gi \vert} \vert}^{P 1} )$$

where the value of degree exponent P1 is determined experimentally, and for definiteness can be set equal 1; for each group Gi the metrics M_Norm(Q) is computed, based on distinctions of mean values of all pixels Tₖᵢ^{R} and mean values of all pixels Tₖᵢ^{D} of each group Gi, under the formula:

$$M\_Norm ( {G}_{i} ) = {\sum }_{( {T}_{ki}^{R} , {T}_{ki}^{D} ) ∈ Gi} ( {\vert \frac{{\sum {T}_{ki}^{R}}_{( {T}_{ki}^{R} , {T}_{ki}^{D} ) ∈ Gi}}{\vert Gi \vert} - \frac{{\sum {T}_{ki}^{D}}_{( {T}_{ki}^{R} , {T}_{ki}^{D} ) ∈ Gi}}{\vert Gi \vert} \vert}^{P2} )$$

where the value of degree exponent P2 is determined experimentally, and for definiteness can be set equal 1;
the common metrics is computed, designated as MR_Norm for groups G0 . . . GM−1 which is based on registration of pixel distinctions Tₖᵢ^{R} and Tₖᵢ^{D} by each of groups except for distinctions of mean values of all pixels Tₖᵢ^{R} and mean values of all pixels Tₖᵢ^{D} of each group Gi, under the formula:

$$MR\_Norm = {\sum }_{i = 0 … M - 1} MR\_Norm ( {G}_{i} ) ;$$

the common metrics is computed, designated as M_Norm, for groups G0 . . . GM−1 which is based on registration of distinctions of mean values of all pixels Tₖᵢ^{R} and mean values of all pixels Tₖᵢ^{D} of each group Gi, under the formula:

$$M\_Norm = {\sum }_{i = 0 … M - 1} M\_Norm ( {G}_{i} ) ;$$

comparison of values of computed metrics MR_Norm and M_Norm is carried out with beforehand defined threshold values, and in a case if MR_Norm is greater than the first defined threshold value or M_Norm is smaller than the second defined threshold value, similarity of the restored pixels neighboring the reference block and restored pixels neighboring the coded block is considered weak; otherwise similarity of the restored pixels neighboring the reference block and restored pixels neighboring the coded block is considered strong;
if similarity of the restored pixels neighboring the reference block and restored pixels neighboring the coded block is weak, correction cannot be applied;
if similarity of the restored pixels neighboring the reference block and restored pixels neighboring the coded block is strong, correction is carried out obligatory.
2. Calculating weighted coefficients Wₖ(i,j),k=0, . . . , N−1 for each pixel (i,j) position the reference block 601 (operation 702). The weighted coefficients Wₖ(i,j) are expressed as following:

Wₖ(i,j)=exp(−C1·Aₖ(i,j)^{C2}+C3),

Aₖ(i,j)=|R_{i,j}−Tₖ^{R}|,

where C1, C2, C3 are parameters, setting nonlinear dependence from the value Aₖ(i,j), are determined experimentally. Here N is a total number of pixels in blocks 612, 613 (or 602, 603). It is necessary to note that weighted coefficients reflect that fact that the closer value R_{i,j} to Tₖ^{R} the more its contribution at determination of parameter of correction of illumination change for the reference block.
3. Calculating the value estD_{i,j} i for each pixel position (i,j) in the reference block 601 (operation 703) according to the following expression:

$${estD}_{i , j} = {\sum }_{{k ∈ 0 … N - 1}_{k \text{:} \vert {T}_{k}^{R} - {T}_{k}^{D} \vert \leq Thr 1 and \vert {T}_{k}^{R} - {R}_{i , j} \vert \leq Thr 2}} {W}_{k} ( i , j ) \cdot {T}_{k}^{D} .$$

Thr1 and Thr2 are predetermined threshold values. Threshold values are used for an exclusion of values of the pixels neighboring the reference block which essentially differ from values R_{i,j} and values Tₖ^{D} neighboring the currently coded block. The expression to calculate estD_{i,j} may be simplified as following:

$$estD = {\sum }_{{k ∈ 0 … N - 1}_{k \text{:} \vert {T}_{k}^{R} - {T}_{k}^{D} \vert \leq Thr 1}} {T}_{k}^{D} .$$

4. Calculating the value estR_{i,j} for each pixel position (i,j) in the reference block 601 (operation 704) according to the following expression:

$${estR}_{i , j} = {\sum }_{{k ∈ 0 … N - 1}_{k \text{:} \vert {T}_{k}^{R} - {T}_{k}^{D} \vert \leq Thr 1 and \vert {T}_{k}^{R} - {R}_{i , j} \vert \leq Thr 2}} {W}_{k} ( i , j ) \cdot {T}_{k}^{R} .$$

Predetermined threshold values Thr1 and Thr2 are same, as in calculating of estD_{i,j}. The expression to calculate estR_{i,j} may be simplified as following:

$$estR = {\sum }_{{k ∈ 0 … N - 1}_{k \text{:} \vert {T}_{k}^{R} - {T}_{k}^{D} \vert \leq Thr 1}} {T}_{k}^{R} .$$

For increasing of accuracy of an estimation of value of parameter of correction of illumination change α_{i,j}, an embodiment provides that for exclusion from consideration of obtained pixels Tₖ^{R} and Tₖ^{D} which belong to already decoded and restored areas of reference and coded frames and which differ from common selection (set) of pixels in the specified areas, following actions are carried out:
grouping pixels Tₖ^{D} so that for all pixels Tₖ^{R}, satisfying condition Tₖ^{R}>LRᵢ and Tₖ^{R}<LRᵢ₊₁ the pixels Tₖ^{D}, which correspond to pixels Tₖ^{R} proceeding from their serial number k=0 . . . N−1 and spatial position in reference and coded frames, are grouped in the groups designated as B(LRᵢ,LR₁₊₁);

$$B ( {LR}_{i} , {LR}_{i + 1} ) = \{ {{T}_{k}^{D}}_{k = 0 … N - 1} : {T}_{k}^{R} > {LR}_{i} ⋀ {T}_{k}^{R} < {LR}_{i + 1} \} ,$$

wherein values LRᵢ, LRᵢ₊₁ define limitations of range determining group B(LRᵢ,LRᵢ₊₁) and satisfy to condition LRᵢ>−1; LRᵢ₊₁>Rᵢ. The number of groups B(LRᵢ,LRᵢ₊₁) N_{B} is defined experimentally and sets the largest possible value of the index i, used at numbering of values (LRᵢ,LRᵢ₊₁):−1<LR₀<LR₀<LR₀ . . . <LR_{NB};
following values are calculated for each group B(LRᵢ,LRᵢ₊₁), defined by values (LRᵢ,LRᵢ₊₁);

$$C\_Plus ( LRi , LRi + 1 ) = {\sum }_{{T}_{k}^{D} ∈ B ( LRi , LRi + 1 )} \{ \begin{matrix}1 , & {T}_{k}^{R} \geq {T}_{k}^{D} + Thr 5 \\ 0 , & {T}_{k}^{R} < {T}_{k}^{D} + Thr 5\end{matrix} \\ C\_Minus ( LRi , LRi + 1 ) = {\sum }_{{T}_{k}^{D} ∈ B ( LRi , LRi + 1 )} \{ \begin{matrix}1 , & {T}_{k}^{R} \leq {T}_{k}^{D} - Thr 5 \\ 0 , & {T}_{k}^{R} > {T}_{k}^{D} - Thr 5 ,\end{matrix}$$

three following conditions are checked if they are satisfied for each pixel Tₖ^{D}εB(LRi,LRi+1) of the group B(LRᵢ,LR₁₊₁);

Condition1:

/C_Plus(LRᵢ,LRᵢ₊₁)−C_Minus(LRᵢ,LRᵢ₊₁)/<Thr6;

Condition2:

C_Plus(LRᵢ,LRᵢ₊₁)−C_Minus(LRᵢ,LRᵢ₊₁)>=Thr6 AND Tₖ^{R}≧Tₖ^{D}−Thr5;

Condition3:

C_Plus(LRi,LRi+1)−C_Minus(LRi,LRi+1)<=Thr6 AND Tₖ^{R}≦Tₖ^{D}−Thr5

if one of the checked conditions 1 . . . 3 is satisfied for the next considered pixel Tₖ^{D}εB(LRi, LRi+1) of group B(LRᵢ,LRᵢ₊₁), the considered pixel Tₖ^{D}εB(LRi,LRi+1) is included in the further calculations of parameters of corrections of illumination of the reference block.
5. Calculating the parameter of correction of illumination change α_{i,j} (operation 705) for each pixel position (i,j) in the reference block 601 based on obtained values estD_{i,j} and estR_{i,j} if estR_{i,j} is not equal 0. Otherwise α_{i,j} assumed to be equal 1. The parameter of correction of illumination change α may be calculated according to the following expression:

$$α = \{ \begin{matrix}( 1 ≪ LogWDC , & if ( estR ≫ CUT\_TH ) == ( estD ≫ CUT\_TH ) \\ ( ( 1 ≪ LogWDC ) \times estD + ( estR ≫ 1 ) ) / estR , & otherwise\end{matrix}$$

, where estD is a first estimation value, estR is a second estimation value, CUT_TH is a cutoff threshold value, Log WDC is an effective number coefficient, << is an arithmetic left shift operator, and >> is an arithmetic right shift operator.
For the practical reasons, correction of illumination is not performed if (Ref_Refᵢ>>CUT_TH)==(Ref_Decᵢ>>CUT_TH), meaning that pixels in a reference template area and decoded template area are quite similar.
6. Performance of correction of illumination change (operation 706) for the reference block 601 based on use of calculated parameters α_{i,j} if similarity of pixels of blocks 602, 603, 612, 613 is accepted as strong.
   The correction of illumination of the reference block may be performed according to the following expression:
      predPartALCᵢ[x,y]=Min(255, (predPartᵢ[x,y]*α+2^{log WDC-1})>>log WDC),
   where predPartᵢ[x, y] is a value of a pixel at coordinate (x, y) of the reference block, predPartALCᵢ[x, y] is a illumination-corrected value of the pixel at coordinate (x, y) of the reference block, α is the parameter of correction of illumination, and log WDC is an effective number coefficient.

An embodiment also provides such correction of values of luminance of pixels of the reference block at which instead of use of intensity of each pixel of the reference block separately, the generalized statistic characteristic of more than one pixel of the reference block can be corrected. For example, for pixels A00, A01, A10, A11 from the block 601 it is possible to calculate a mean value for which the correction parameter will be calculated according to one or more embodiments, described above. Then, the mean value of set of pixels A00, A01, A10, A11 will be replaced with the corrected value. In other embodiment the pixels of the reference block are grouped in one or more groups of pixels based on obviously determined common feature (for example—proximity of intensities), with the subsequent selection of common parameter (such, as for example a mean value), its correction and final replacement of original value of common parameter for the selected group of pixels on corrected one.

An embodiment may be based on an idea described below. Usually the values of the pixels neighboring the reference block are defined as a group of pixels that are immediately adjacent the reference block. However the procedure of search of the reference block can select such displacement vector that the values of the pixels in the specified pixels are not similar adequately to the values of the pixels corresponding to them neighboring the currently coded block. Moreover the values of pixels immediately adjacent the reference block can differ considerably from the values of the reference block. In these cases the correction of illumination and contrast change can be performed incorrectly.

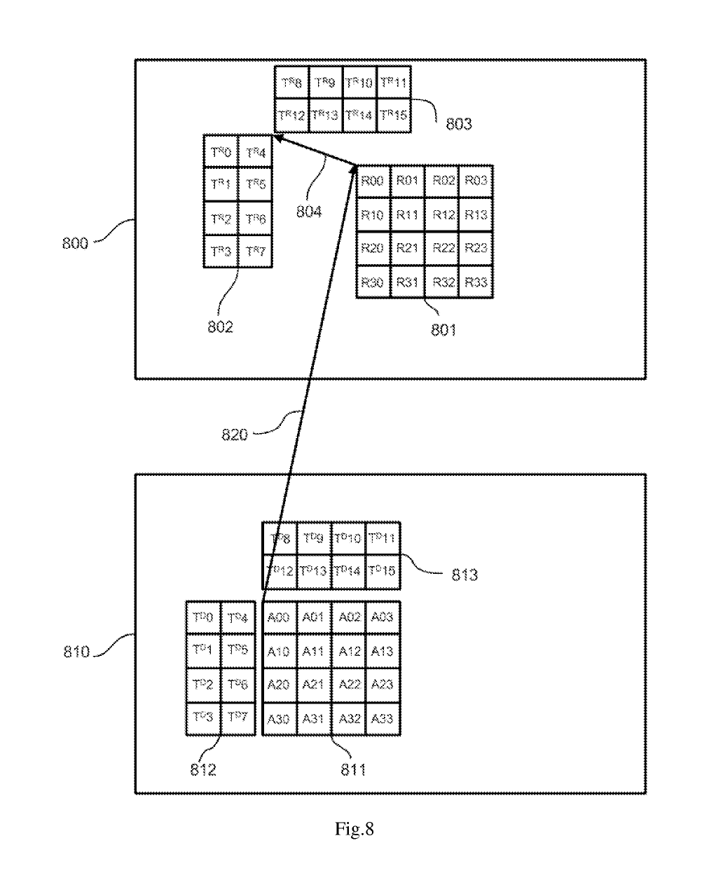

One or more embodiments may make usage of float. (relative to the reference block) position of the mentioned group of the pixels neighboring the reference block. FIG. 8 explains proposed method in accordance with an embodiment. Referring FIG. 8, on each iteration of procedure of search of a reference block the displacement vector (DV) 820 is assigned for the current block 811 of the currently coded frame 810. The DV points to the reference block 801 of the reference frame 800. Coordinates of the group of pixels of the reference frame (which is formed by pixels of blocks 802 and 803) are determined by additional refinement displacement vector 804. The refinement displacement vector 804 is result of additional displacement estimation procedure. Wherein such displacement vector 804 is determined which defines minimum value of an error function defined similarity degree of blocks 812, 813 and blocks 802, 803 correspondingly. Such known functions can be an error function: Means Square Error, Sum of Absolute Differences, Mean Removed Sum of Absolute Differences etc. Vector 804 can be determined implicitly during encoding and decoding process without transmitting any additional information in the output bit stream.

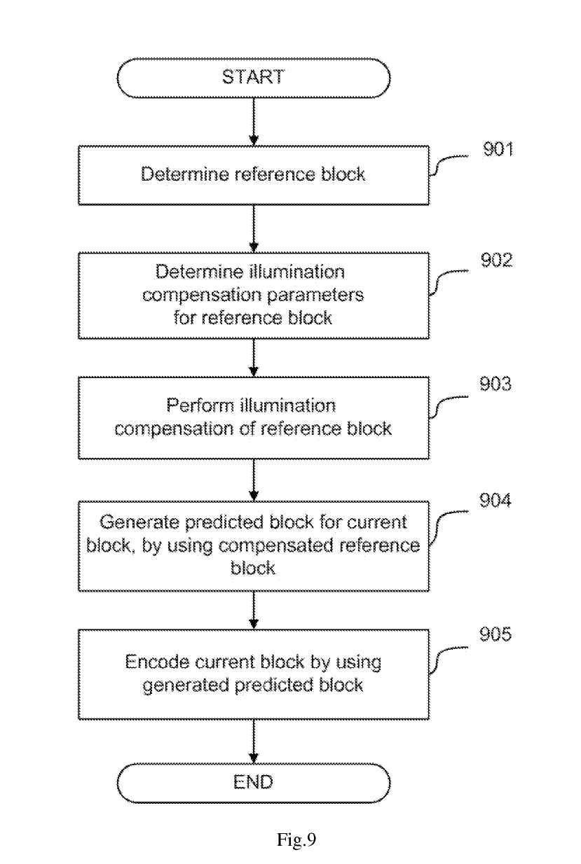

FIG. 9 is a flowchart which describes a method for multi-view video sequences encoding based on the illumination correction according to an embodiment.

All inter macroblock modes in P-slices of depended views are checked with Adaptive luminance compensation (ALC) enabled and disabled, then the best mode is chosen by the encoder.

ALC is a coding tool which suppresses local illumination changes between encoded macroblock and predicted blocks that belong to an interview reference frame. This technology covers several aspects: compensation model, luminance discrepancy estimation process, motion (disparity) vector derivation and signaling mechanism.

It's well known that the majority of natural multi-view sequences and even some of synthesized multi-view sequences usually demonstrate inter-view mismatches in particular, local luminance discrepancy between object projections captured by adjacent cameras of 3D capturing system even if they are geometrically matched accurately. Suppressing of a luminance discrepancy allows increasing the quality of interview prediction of blocks. It decreases rate of residuals and results in PSNR (peak signal-to-noise ratio) increase of encoded frames.

The decoded image parts are used for ALC parameters calculation and for making correction. One-bit flag for each inter macroblock is signalled to indicate the usages of ALC, including macroblocks encoded in P-Skip mode, and that belongs to dependent views of texture component of multiview+depth video.

For example, mb_alc_skip_flag and mb_alc_flag may be used as one-bit flags.

When mb_alc_skip_flag is equal to 1, the adaptive luminance compensation is applied for the current macroblock. When mb_alc_skip_flag is equal to 1, the current macroblock shall be coded as P_Skip. When mb_alc_skip_flag is equal to 0, the adaptive luminance compensation is not applied for the current macroblock. When mb_alc_skip_flag is not presented, mb_alc_skip_flag may be inferred to be equal to 0.

When mb_alc_flag is equal to 1, the adaptive luminance compensation mode is in use for the current macroblock. When mb_alc_flag is equal to 1, the current macroblock shall be coded as at least one of P_L0_{—}16×16, P_L0_{—}16×8, or P_L0_{—}8×16. When mb_alc_flag is equal to 0, the adaptive luminance compensation mode is not in use for the current macroblock. When mb_alc_flag is not presented, mb_alc_flag may be inferred to be equal to 0.

In operation 901, a reference block which is used for generation of a predicted block is determined.

Motion vector prediction aligned for inter-view motion vector prediction is used for P_SKIP mode if ALC is turned on for the macroblock. In particular, If ALC tool is used, reference index ref IdxL0 is derived as an interview picture that appears first in RefPicList0. The depth-based derivation process for median luma motion vector prediction may be invoked for deriving motion vector prediction mvpL0 for P_Skip.

In order to perform motion estimation procedure that generates displacement (disparity) vector, “limited” search zone is defined based on an assumption that an input multiview video sequence is already rectified. In particular, search zone sizes may be defined as follows:

Search Zone Height may be defined to be equal to 6 quarter pixel positions
Search Zone Width may be defined to be equal to 20 quarter pixel positions.

In order to provide higher precision of displacement vector determination so-called “Fast Full Search” might be used at the encoder side for ALC encoding modes.

To improve accuracy of disparity vector estimation, considering potential discrepancy of luminance between encoded and predicted blocks, it's proposed to modify distortion metric from SAD to so-called MR_SAD4×4_DC. This change deals with encoder part only and is an informative component of ALC technology.

First, MR_SAD4×4 is defined as a sum of mean-removed SADs over all sub-blocks 4×4 comprising currently encoded block which sizes are (H, W):

$$MR\_SAD4 \times 4 = {\sum }_{k = 0 , m = 0}^{k = H / 4 , m = W / 4} {\sum }_{i = 0 ; j = 0}^{i = 3 ; j = 3} \vert {X}_{4 k + i , 4 m + j} - M 4 [ X , 4 k , 4 m ] - {R}_{4 k + i + {DV}_{y} , 4 m + j + {DV}_{x}} + M 4 [ R , 4 k + {DV}_{y} , 4 m + {DV}_{x} ] \vert , \\ where$$

$$M 4 [ X , x , y ] = \frac{1}{16} {\sum }_{i = y}^{y + 3} {\sum }_{j = x}^{x + 3} {X}_{i , j} ,$$

R is a reference frame, X is an encoded frame, H is height of an encoded block, and W is width of an encoded block.

Then, taking into account possible DC differences, the following modification is being done, making distortion metric to be sensitive to both DC differences and mean-removed differences:

$$MR\_SAD4 \times 4 \_DC = MR\_SAD4 \times 4 + {\sum }_{k = 0 , m = 0}^{k = H / 4 , m = W / 4} \vert M 4 [ X , 4 k , 4 m ] - M 4 [ R , 4 k + {DV}_{y} , 4 m + {DV}_{x} ] \vert .$$

Experiments show that whereas complexity of the encoder is not increased due-to use of MR_SAD4×4_DC instead of SAD metric, compression gain may slightly go up.

ALC compensation may be applicable for luma samples. For each prediction mode to be tested in P-Slices of texture dependent views, a macroblock is divided into non-overlapped blocks referred further as predPartᵢ[x, y] with sizes (psx,psy), such that these non-overlapped blocks are ordered in a decoding order, and ALC is applied for each predPartᵢ[x, y] sequentially. To derive a weight factor, the template row and the template column (i.e., the above and the left templates) are selected. The template row length equals psx and the template column height equals psy. Table below shows how block sizes are defined based on mb_type value:

| mb_type | psx | psy |
|---|---|---|
| P_L0_16×16 | 16 | 16 |
| P_L0_L0_16×8 | 16 | 8 |
| P_L0_L0_8×16 | 8 | 16 |
| P_Skip | 16 | 16 |

In operation 902, parameters of correction of illumination and contrast change of the determined reference block are determined.

To perform ALC, for each predPartᵢ[x, y], weight factor W is calculated as follows: two intermediate variables Ref_Dec and Ref_Ref are calculated:

$${Ref\_Dec}_{i} = 1 + {\sum }_{m = 1 … psy} {LTDec}_{i} [ m ] \times \{ \begin{matrix}1 , & \vert {LTDec}_{i} [ m ] - {LTRef}_{i} [ m ] \vert < TH \\ 0 , & otherwise\end{matrix} + {\sum }_{k = 1 … psx} {UTDec}_{i} [ k ] \times \{ \begin{matrix}1 , & \vert {UTDec}_{i} [ k ] - {UTRef}_{i} [ k ] \vert < TH \\ 0 , & otherwise ,\end{matrix} \\ {Ref\_Ref}_{i} = 1 + {\sum }_{m = 1 … psy} {LTRef}_{i} [ m ] \times \{ \begin{matrix}1 , & \vert {LTDec}_{i} [ m ] - {LTRef}_{i} [ m ] \vert < TH \\ 0 , & otherwise\end{matrix} + \\ {\sum }_{k = 1 … psx} {UTRef}_{i} [ k ] \times \{ \begin{matrix}1 , & \vert {UTDec}_{i} [ k ] - {UTRef}_{i} [ k ] \vert < TH \\ 0 , & otherwise ;\end{matrix}$$

weight W is calculated as follows:

$$W = \{ \begin{matrix}\begin{matrix}\begin{matrix}( 1 << Log WDC , if ( {Ref\_Ref}_{i} >> CUT\_TH ) == \\ ( {Ref\_Dec}_{i} >> CUT\_TH )\end{matrix} & \end{matrix} \\ \begin{matrix}( ( 1 << Log WDC ) \times {Ref\_Dec}_{i} + \\ ( {Ref\_Ref}_{i} >> 1 ) ) / {Ref\_Ref}_{i} , otherwise ,\end{matrix}\end{matrix}$$

where “/” is an integer division with rounding to zero, “>>” means arithmetic right shift, TH is a predefined threshold (i.e., 30), and CUT_TH is another predefined threshold (i.e., 4).

The determination of the parameters of correction of illumination and contrast change includes:
receiving restored (encoded and then decoded) values of the pixels neighboring the current block and values of the pixels neighboring the reference block of the reference frame; wherein the received pixels are selected from one or more spatial areas, each of which is characterized by beforehand set spatial proximity in relation to the current block of the coded frame and the current reference block of the reference frame; the selection of the specified areas, which are adjacent in relation to the current block of the coded frame and the current reference block of the reference frame, is performed proceeding from type of the spatial conversion applied subsequently for encoding of inter-frame difference, already decoded pixels, proceeding from the sizes of already coded neighboring blocks, and also their logic connections with the currently coded block (logic connections are understood as specified objectively existing dependences between the current block and the neighboring blocks, set, for example, by a coding method. In this case such connection can be combination of the neighboring blocks and the currently coded block together in a single element of encoding for which the common vector of displacement is set); the estimation of similarity of set of the pixels neighboring the coded block and set of the pixels neighboring the reference block is calculated additionally. Value of the calculated estimation of similarity of pixels is used as an additional condition at decision-making on use of correction of illumination of pixels of the reference block
excluding from consideration at determination of parameters of illumination change the pixels belonged to already decoded and restored areas of the reference and coded frames and which differed from the common selection (set) of pixels in the specified areas by the predetermined criterion, which is based on the analysis of distribution of values of pixels in the specified areas, computation of the static characteristics and also comparison of values of all checked pixels and static characteristics in the specified areas;
determining numerical relations between the values of the pixels of the reference block and the values of the pixels neighboring the reference block and relations between the restored values of the pixels neighboring the currently coded block and the values of the pixels neighboring the reference block; determining an illumination change correction parameters for correction of difference in illumination of the reference block based on the numerical relations determined on the previous step, values of the pixels of the reference block, restored values of the pixels neighboring the currently coded block and values of the pixels neighboring the reference block.

At stage 903, by using the determined parameters of correction of illumination change, correction of the reference block is performed.

ALC is performed for all values of each predPartᵢ[x, y] of the macroblock (i=1 . . . n). Predicted samples predPartALCᵢ[x, y] are derived as follows:

predPartALCᵢ[x, y]=Min(255, (predPartᵢ[x, y]*W+2^{log WDC-1})>>log WDC),
where log WDC may be set to 15.

Correction of differences of illumination between the reference block and the currently coded block is performed based on the parameters determined at previous step when a degree of similarity of the pixels neighboring the coded block and considered together and the pixels neighboring the reference block and considered together is greater than threshold value which can be set beforehand or adaptively changes during the process of correction.

At stage 904, by using the illumination corrected reference block, a predicted block for the current block is generated. For example, corrected blocks predPartALCᵢ[x, y] are used for compensation of encoded (decoded) macroblock that spatially corresponds to predPartALCᵢ[x, y].

At stage 905, by using the generated predicted block, the current block is encoded. In particular, information about the reference block is encoded if it is needed for decoding. For example, a flag, indicating whether to use a correction of illumination scheme when a decoder decodes the currently encoded block, may be generated. At the same time the determined parameters of correction of illumination change are not encoded and are not placed in bit stream.

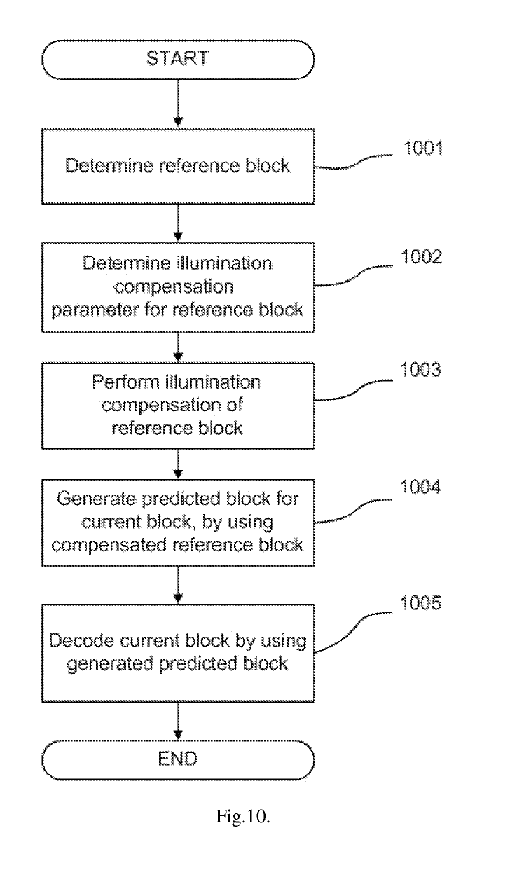

FIG. 10 illustrates a method for multi-view video sequences decoding based on the correction of illumination change according to an embodiment. Referring to FIG. 10, information about a reference block is decoded in case of requirements of decoding. For example, it may be determined whether to use a correction of illumination scheme, based on a flag generated by an encoder. The decoded information can be used for determination of a reference block at stage 1001.

At stage 1002, parameters of correction of illumination change for correction of the reference block are determined.

To perform ALC, for each predPartᵢ[x, y], weight factor W is calculated as follows: two intermediate variables Ref_Dec and Ref_Ref are calculated:

$${Ref\_Dec}_{i} = 1 + {\sum }_{m = 1 … psy} {LTDec}_{i} [ m ] \times \{ \begin{matrix}1 , & \vert {LTDec}_{i} [ m ] - {LTRef}_{i} [ m ] \vert < TH \\ 0 , & otherwise\end{matrix} + {\sum }_{k = 1 … psx} {UTDec}_{i} [ k ] \times \{ \begin{matrix}1 , & \vert {UTDec}_{i} [ k ] - {UTRef}_{i} [ k ] \vert < TH \\ 0 , & otherwise ,\end{matrix} \\ {Ref\_Ref}_{i} = 1 + {\sum }_{m = 1 … psy} {LTRef}_{i} [ m ] \times \{ \begin{matrix}1 , & \vert {LTDec}_{i} [ m ] - {LTRef}_{i} [ m ] \vert < TH \\ 0 , & otherwise\end{matrix} + \\ {\sum }_{k = 1 … psx} {UTRef}_{i} [ k ] \times \{ \begin{matrix}1 , & \vert {UTDec}_{i} [ k ] - {UTRef}_{i} [ k ] \vert < TH \\ 0 , & otherwise ;\end{matrix}$$

weight W is calculated as follows:

$$W = \{ \begin{matrix}\begin{matrix}\begin{matrix}( 1 << Log WDC , if ( {Ref\_Ref}_{i} >> CUT\_TH ) == \\ ( {Ref\_Dec}_{i} >> CUT\_TH )\end{matrix} & \end{matrix} \\ \begin{matrix}( ( 1 << Log WDC ) \times {Ref\_Dec}_{i} + \\ ( {Ref\_Ref}_{i} >> 1 ) ) / {Ref\_Ref}_{i} , otherwise ,\end{matrix}\end{matrix}$$

where “/” is an integer division with rounding to zero, “>>” means arithmetic right shift, TH is a predefined threshold (i.e., 30), and CUT_TH is another predefined threshold (i.e., 4).

The determination of the parameters of correction of illumination change includes
receiving restored (encoded and then decoded) values of the pixels neighboring the current block and values of the pixels neighboring the reference block of the reference frame; wherein the received pixels are selected from one or more spatial areas, each of which is characterized by beforehand set spatial proximity in relation to the current block of the coded frame and the current reference block of the reference frame; the selection of the specified areas, which are adjacent in relation to the current block of the coded frame and the current reference block of the reference frame, is performed proceeding from type of the spatial conversion applied subsequently for encoding of inter-frame difference, already decoded pixels, proceeding from the sizes of already coded neighboring blocks, and also their logic connections with the currently coded block (logic connections are understood as specified objectively existing dependences between the current block and the neighboring blocks, set, for example, by a coding method. In this case such connection can be combination of the neighboring blocks and the currently coded block together in a single element of encoding for which the common vector of displacement is set); the estimation of similarity of set of the pixels neighboring the coded block and set of the pixels neighboring the reference block is calculated additionally. Value of the calculated estimation of similarity of pixels is used as an additional condition at decision-making on use of correction of illumination of pixels of the reference block.
excluding from consideration at determination of parameters of illumination change the pixels belonged to already decoded and restored areas of the reference and coded frames and which differed from the common selection (set) of pixels in the specified areas by the predetermined criterion, which is based on the analysis of distribution of values of pixels in the specified areas, computation of the static characteristics and also comparison of values of all checked pixels and static characteristics in the specified areas;
determining numerical relations between the values of the pixels of the reference block and the values of the pixels neighboring the reference block and relations between the restored values of the pixels neighboring the currently coded block and the values of the pixels neighboring the reference block;
determining an illumination change correction parameters for correction of difference in illumination of the reference block based on the numerical relations determined on the previous step, values of the pixels of the reference block, restored values of the pixels neighboring the currently coded block and values of the pixels neighboring the reference block.

At stage 1003, by using the determined parameters of correction of illumination change, correction of the reference block is performed.

ALC is performed for all values of each predPartᵢ[x, y] of the macroblock (i=1 . . . n). Predicted samples predPartALCᵢ[x, y] are derived as follows:

predPartALCᵢ[x, y]=Min(255, (predPartᵢ[x, y]*W+2^{log WDC-1)>>log WDC),}
where log WDC may be set to 15.

Correction of differences of illumination between the reference block and the currently coded block is performed based on the parameters determined at previous step if a degree of similarity of the pixels neighboring the coded block both considered together and the pixels neighboring the reference block and considered together is greater than threshold value which can be set beforehand or adaptively changes during the process of correction.

At stage 1004, by using the illumination corrected reference block, the predicted block for the current block is generated. For example, corrected blocks predPartALCᵢ[x, y] are used for compensation of encoded (decoded) macroblock that spatially corresponds to predPartALCᵢ[x, y]. At stage 1005, by using the generated predicted block, the current block is decoded.

Embodiments can be used at encoding and decoding of multi-view video sequences.

Methods according to embodiments may be recorded in non-transitory computer-readable media including program (computer readable) instructions to implement various operations embodied by a computing device such as a computer. The computing device may have one or more processors. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The non-transitory computer-readable media may also be a distributed network, so that the program instructions are stored and executed in a distributed fashion. The program instructions may be executed by one or more processors or processing devices. The computer-readable media may also be embodied in at least one application specific integrated circuit (ASIC) or Field Programmable Gate Array (FPGA). The described hardware devices may be configured to act as one or more software modules in order to perform the operations of the above-described example embodiments, or vice versa.

Although example embodiments have been shown and described, it would be appreciated by those skilled in the art that changes may be made in these example embodiments without departing from the principles and spirit of the disclosure, the scope of which is defined in the claims and their equivalents.

What is claimed is:

1. The method for multi-view video sequences decoding comprises:
calculating a parameter of correction of illumination using pixels neighboring a currently decoded block and pixels neighboring a reference block;
performing correction of illumination for the reference block using the parameter of correction of illumination; and
decoding the currently decoded block using the illumination-corrected reference block.

2. The method of claim 1, wherein the calculating the parameter of correction of illumination comprising:
determining numerical relations between values of the pixels neighboring the currently decoded block and values of the pixels neighboring the reference block; and
determining the parameter of correction of illumination based on the numerical relations.

3. The method of claim 2, wherein the determining the numerical relations comprising:
calculating a first estimation value estD as
$$estD = {\sum }_{{k ∈ 0 … N - 1}_{k \text{:} \vert {T}_{k}^{R} - {T}_{k}^{D} \vert \leq Thr 1}} {T}_{k}^{D} ,$$
where Tₖ^{D} is value of k-th pixel neighboring the currently decoded block, Tₖ^{R} is value of k-th pixel neighboring the reference block, Thr1 is a first threshold value, and N is a number of the pixels neighboring the currently decoded block; and
calculating a second estimation estR as
$$estR = {\sum }_{{k ∈ 0 … N - 1}_{k \text{:} \vert {T}_{k}^{R} - {T}_{k}^{D} \vert \leq Thr 1}} {T}_{k}^{R} .$$

4. The method of claim 2, wherein the determining the parameter of correction of illumination comprising:
calculating the parameter of correction of illumination α as
$$α = \{ \begin{matrix}( 1 << Log WDC , if ( estR >> CUT\_TH ) == ( estD >> CUT\_TH ) \\ ( ( 1 << Log WDC ) \times estD + ( estR >> 1 ) / estR , otherwise ,\end{matrix}$$
where estD is a first estimation value, estR is a second estimation value, CUT_TH is a cutoff threshold value, Log WDC is an effective number coefficient, << is an arithmetic left shift operator, and >> is an arithmetic right shift operator.

5. The method of claim 1, wherein the performing correction of illumination for the reference block comprising:
multiplying a value of each pixel of the reference block on the parameter of correction of illumination.

6. The method of claim 5, wherein the multiplying the value of each pixel of the reference block comprising:
calculating the illumination-corrected reference block as predPartALCᵢ[x, y]=Min(255, (predPartᵢ[x, y]*α+2^{log WDC-1})>>log WDC), where predPartᵢ[x, y] is a value of a pixel at coordinate (x, y) of the reference block, predPartALCᵢ[x, y] is a illumination-corrected value of the pixel at coordinate (x, y) of the reference block, α is the parameter of correction of illumination, and log WDC is an effective number coefficient.

7. The method of claim 1, wherein the pixels neighboring the currently decoded block are pixels which had been previously decoded.

8. The method of claim 1, further comprising:
determining the reference block corresponding to the currently decoded block using a displacement vector.

9. The method of claim 1, further comprising:
determining whether to use a correction of illumination scheme based on a flag generated by an encoder.

10. A non-transitory computer-readable medium comprising a program for instructing a computer to perform the method of claim 1.

11. The method for multi-view video sequences encoding comprises:
determining a reference block that is used for generating a currently encoded block;
calculating a parameter of correction of illumination using pixels neighboring the currently encoded block and pixels neighboring the reference block;
performing correction of illumination for the reference block using the parameter of correction of illumination; and
encoding the currently encoded block using the illumination-corrected reference block.

12. The method of claim 11, wherein the calculating the parameter of correction of illumination comprising:
determining numerical relations between values of the pixels neighboring the currently encoded block and values of the pixels neighboring the reference block; and
determining the parameter of correction of illumination based on the numerical relations.

13. The method of claim 12, wherein the determining the numerical relations comprising:
calculating a first estimation value estD as
$$estD = {\sum }_{{k ∈ 0 … N - 1}_{k \text{:} \vert {T}_{k}^{R} - {T}_{k}^{D} \vert \leq Thr 1}} {T}_{k}^{D} ,$$
where Tₖ^{D} is value of k-th pixel neighboring the currently encoded block, Tₖ^{R} is value of k-th pixel neighboring the reference block, Thr1 is a first threshold value, and N is a number of the pixels neighboring the currently encoded block; and
calculating a second estimation estR as
$$estR = {\sum }_{{k ∈ 0 … N - 1}_{k \text{:} \vert {T}_{k}^{R} - {T}_{k}^{D} \vert \leq Thr 1}} {T}_{k}^{R} .$$

14. The method of claim 12, wherein the determining the parameter of correction of illumination comprising:
calculating the parameter of correction of illumination α as
$$α = \{ \begin{matrix}( 1 << Log WDC , if ( estR >> CUT\_TH ) == ( estD >> CUT\_TH ) \\ ( ( 1 << Log WDC ) \times estD + ( estR >> 1 ) / estR , otherwise ,\end{matrix}$$
where estD is a first estimation value, estR is a second estimation value, CUT_TH is a cutoff threshold value, Log WDC is an effective number coefficient, << is an arithmetic left shift operator, and >> is an arithmetic right shift operator.

15. The method of claim 11, wherein the performing correction of illumination for the reference block comprising:
multiplying a value of each pixel of the reference block on the parameter of correction of illumination.

16. The method of claim 15, wherein the multiplying the value of each pixel of the reference block comprising:
calculating the illumination-corrected reference block as predPartALCᵢ[x, y]=Min(255, (predPartᵢ[x, y]*α+2^{log WDC-1})>>log WDC), where predPartᵢ[x, y] is a value of a pixel at coordinate (x, y) of the reference block, predPartALCᵢ[x, y] is a illumination-corrected value of the pixel at coordinate (x, y) of the reference block, α is the parameter of correction of illumination, and log WDC is an effective number coefficient.

17. The method of claim 11, wherein the determining the reference block comprising:
determining a displacement vector indicating the reference block corresponding the currently encoded block based on a discrepancy of luminance between the currently encoded block and the reference block.

18. The method of claim 11, wherein the determining the reference block comprising:
calculating mean-removed SAD (sum of absolute differences) between the currently encoded block and a reference block candidate, over sub-blocks included in the currently encoded block;
calculating a mean discrepancy of luminance between the currently encoded block and the reference block candidate; and
determining a displacement vector indicating the reference block corresponding the currently encoded block using the mean-removed SAD and the mean discrepancy of luminance.

19. The method of claim 11, further comprising:
generating a flag indicating whether to use a correction of illumination scheme when a decoder decodes the currently encoded block.

20. A non-transitory computer-readable medium comprising a program for instructing a computer to perform the method of claim 11.
